(19) United States
(12) Patent Application Publication
(10) Pub. No.: US 2008/0229327 A1
(43) Pub. Date: Sep. 18, 2008

(54) Information processing apparatus, information processing mehtod and computer program product

(75) Inventor: Eiichiro Yoshida, Tokyo (JP)

Correspondence Address: HARNESS, DICKEY & PIERCE, P.L.C., P.O. BOX 8910, RESTON, VA, 20195, US

(73) Assignee: Ricoh Company, Limited

(21) Appl. No.: 12/073,750

(22) Filed: Mar. 10, 2008

(30) Foreign Application Priority Data
Mar. 16, 2007 (JP) 2007-067971

(51) Int. Cl. G06F 9/46

(52) U.S. Cl. 719/313

(57) ABSTRACT

An information processing apparatus includes a user interface layer that accepts from a user an input of a request for executing a process and an input of operation information at the time of performing the process; an application layer including a plurality of applications that each perform the process according to the input execution request; a plurality of resources commonly used by the applications; an authority determining unit that determines, when a process with the input operation information is requested from one of the applications to an arbitrary one of the resources, whether the user has authority to use the operation information at the arbitrary resource; and an application shared service layer including a lower-layer application that controls the resource with the operation information when it is determined that the user has authority to use.

### CROSS-REFERENCE TO RELATED APPLICATIONS

The present application claims priority to and incorporates by reference the entire contents of Japanese priority document 2007-067971 filed in Japan on Mar. 16, 2007.

### BACKGROUND OF THE INVENTION

1. Field of the Invention

The present invention relates to an information processing apparatus and an information processing program that control resources for use by a plurality of applications.

2. Description of the Related Art

In recent years, with the improvement of computer technologies, various functions tend to be accommodated in one apparatus. The Multi Function Peripheral (MFP) is one of such an apparatus. In the MFP, printer, copy, and facsimile functions, which are conventionally disposed in their respective casings, are accommodated in one casing.

In the MFP, a displaying unit, a printing unit, an image pick-up unit, and other units are provided in one casing. Also, three types of software corresponding to printer, copy, and facsimile apparatuses are provided. By switching these pieces of software, the MFP operates as a printer, copy, or facsimile apparatus.

The MFP having such a plurality of functions tends to be used by a plurality of users in a shared manner. However, it may not be preferable that all functions incorporated in the MFP are provided to all users.

To address this case, currently suggested is a technology of providing a different operating environment for each user (for example, refer to Japanese Patent Application Laid-Open Publication No. 2005-175530). According to the technology disclosed in this patent gazette, an access right to an item of an operating environment is set for each user using the apparatus, and an application is executed according to the operating environment. With this, an optimum operating environment can be provided that is different for each user.

However, in the technology disclosed in the patent gazette mentioned above, an item is set for each operation of each application. Therefore, when an output in full color is desired to be inhibited for any user irrespectively of print or copy, for example, settings have to be made for every application, thereby resulting in complicated settings.

### SUMMARY OF THE INVENTION

It is an object of the present invention to at least partially solve the problems in the conventional technology.

According to an aspect of the present invention, an information processing apparatus includes an input accepting unit that accepts from a user an input of a request for executing a process and an input of an operation setting at the time of performing the process; a plurality of applications that each perform the process according to the request for executing the process input from the user; a plurality of resources commonly used by the applications; a resource authority determining unit that determines, when a request for the process with the input operation setting is issued from one of the applications to an arbitrary one of the resources, whether the user inputting the operation setting has authority to use the operation setting at the arbitrary resource; and a resource control application that controls the arbitrary resource with the operation setting when the resource authority determining unit determines that the user has authority to use.

According to another aspect of the present invention, an information processing method includes accepting from a user an input of a request for executing a process of an application and an input of an operation setting at the time of performing the process; determining, when a request for the process with the input operation setting is issued from the application to an arbitrary one of the resources which are commonly used by a plurality of applications, whether the user inputting the operation setting has authority to use the operation setting at the arbitrary resource; and controlling the arbitrary resource with the operation setting when it is determined that the user has authority to use.

According to still another aspect of the present invention, a computer program product that includes a computer-readable recording medium that stores therein a computer program that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of the configuration of an MFP according to a first embodiment;

FIG. 2 is a drawing of a table structure of a corresponding resource management table of the MFP according to the first embodiment;

FIG. 3 is a drawing of an example of a table structure of a scanner authority setting table of the MFP according to the first embodiment;

FIG. 4 is a flowchart of a procedure until an application executes a process in the MFP according to the first embodiment;

FIG. 5 is a sequence diagram of an execution procedure when an instruction for executing a copy process is issued from an application control layer in the MFP according to the first embodiment;

FIG. 6 is a flowchart of a procedure of a process for determining authority performed at a scanner application in the MFP according to the first embodiment;

FIG. 7 is a block diagram of the configuration of an MFP according to a second embodiment;

FIG. 8 is a drawing of an example of a table structure of a printer authority setting table of MFP according to the second embodiment;

FIG. 9 is a drawing of a table structure of a plotter authority setting table of the MFP according to the second embodiment;

FIG. 10 is a sequence diagram of an execution procedure when an instruction for executing a two-color print process from an application control layer of the MFP according to the second embodiment;

FIG. 11 is a flowchart of a procedure of a process for determining authority when a “two-color” print process is requested from a user in the MFP according to the second embodiment;

FIG. 12 is a block diagram of the configuration of an MFP according to a first modification example of the second embodiment;

FIG. 13 is a sequence diagram of an execution procedure when an instruction for executing a print process is issued from an application control layer of the MFP according to the first modification example of the second embodiment;

FIG. 14 is a sequence diagram of an execution procedure when an instruction for executing a print process is issued from the application control layer of the MFP according to the first modification example of the second embodiment;

FIG. 15 is a block diagram of the configuration of an MFP according to a second modification example of the second embodiment;

FIG. 16 is a drawing of an example of a table structure of an authority setting table included in an authority managing unit of the MFP according to the second modification example of the second embodiment;

FIG. 17 is a block diagram of the configuration of an MFP according to a third modification example of the second embodiment;

FIG. 18 is a block diagram of the configuration of an MFP according to a third embodiment;

FIG. 19 is a sequence diagram of an execution procedure when an instruction for executing a print process is issued from an application control layer of the MFP according to the third embodiment;

FIG. 20 is a block diagram of the configuration of an MFP according to a fourth embodiment;

FIG. 21 is a block diagram of the configuration of an MFP according to a fifth embodiment;

FIG. 22 is a sequence diagram of an execution procedure when an instruction for executing a two-color print process is issued from an application control layer of the MFP according to the fifth embodiment;

FIG. 23 is a sequence diagram of an execution procedure when an instruction for executing a full-color print process is issued from the application control layer of the MFP according to the fifth embodiment;

FIG. 24 is a sequence diagram of an execution procedure when an instruction for executing a full-color print process is issued from the application control layer of the MFP according to the fifth embodiment;

FIG. 25 is a block diagram of the configuration of an MFP according to a sixth embodiment;

FIG. 26 is a sequence diagram of an execution procedure when an instruction for executing a full-color print process is issued from the application control layer of the MFP according to the sixth embodiment; and

FIG. 27 is a block diagram of a hardware configuration of the MFPs.

### DETAILED DESCRIPTION OF THE PREFERRED EMBODIMENTS

With reference to the attached drawings, exemplary embodiments of the information processing apparatus and information processing program according to the present invention are explained in detail below.

As one embodiment of the present invention, the present invention is exemplarily applied to a so-called Multi Function Peripheral (MFP) 100, which is an information processing apparatus combined with a copy function, a facsimile (FAX) function, a print function, a scanner function, a function of distributing input images (document images read through the scanner function and images input through the printer or FAX function), and other functions. Also, the configuration of the embodiment may be applied to an image information processing apparatus other than the MFP.

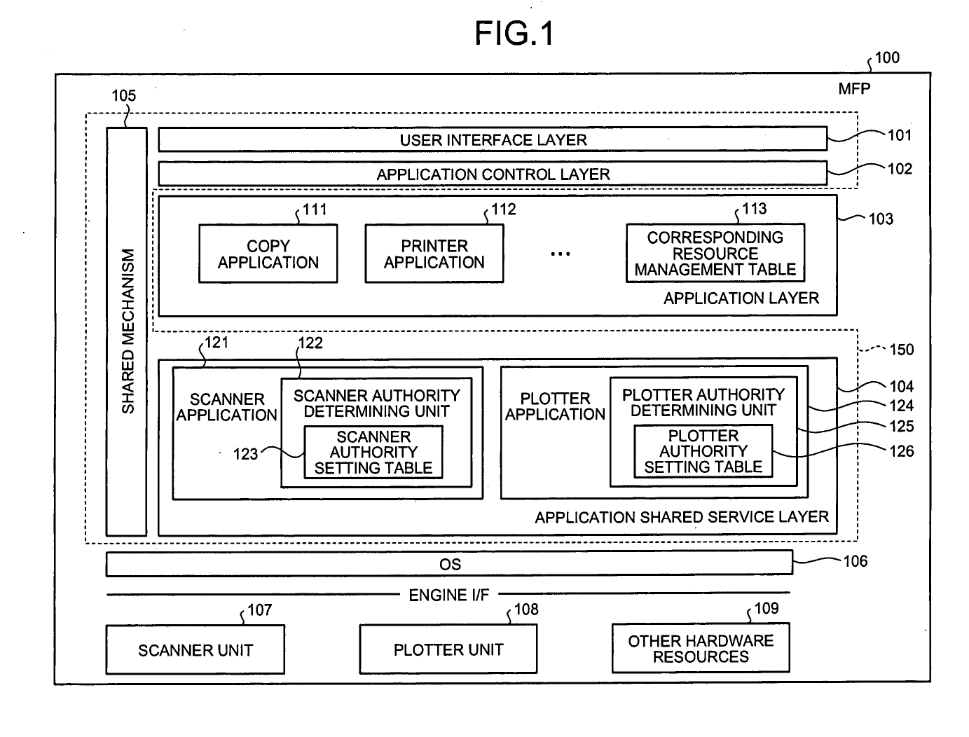

FIG. 1 is a block diagram of the configuration of the MFP 100 according to a first embodiment. As depicted in the drawing, the MFP 100 includes therein a user interface layer 101, an application control layer 102, an application layer 103, an application shared service layer 104, a shared mechanism 105, an Operating System (OS) 106, a scanner unit 107, a plotter unit 108, and other hardware resources 109, such as a monochrome line printer or facsimile.

The MFP 100 according to the present embodiment performs processes with such a hierarchical structure. In the conventional MFPs, merely sharing an Application Program Interface (API) common to applications in a service layer is achieved, and sectioning is not aimed at enhancing functions. Therefore, in the conventional MFP, the existing resources are reused to successfully improve efficiency of developing the existing applications, but the problem that the number of development processes cannot be reduced at the time of addressing a new function or solution has arisen.

Such a problem occurs not restrictively in the MFP, but is a common problem for any image information processing apparatus capable of incorporating a plurality of applications for image processing.

To get around this problem, in the MFP 100, each role of work is clarified in the hierarchical structure explained above, thereby making it possible to add a new function or address a new solution. Next, each component of the MFP 100 is explained.

The user interface layer 101, the application control layer 102, the application shared service layer 104, and the shared mechanism 105 are referred to as a framework unit 150.

The user interface layer 101 causes data to be displayed on a displaying unit not shown, and accepts an input operation by a user. Also, the user interface layer 101 outputs information accepted through an input operation to the application control layer 102 or the application layer 103, or causes information input from the application control layer 102 or the application layer 103 to be displayed on the displaying unit.

Furthermore, the user interface layer 101 accepts from the user an input of a request for executing a process with a function included in the MFP and an input of operation information at the time of performing the process. This operation information serves as an operation setting used for processing in the device or others. Upon accepting such a process request, the user interface layer 101 outputs to an application performing the process a request for executing the process, the operation information, and a user name identifying the user that has requested the process.

The application layer 103 has stored therein software that executes functions included in the MFP 100, such as printer, copy, and transmission functions. The application layer 103 includes a copy application 111, which is an application for copying, a printer application 112, which is an application for printer having a Page Description Language (PDL) or Printer Control Language (PCL) and a PostScript (PS), and a corresponding resource management table 113 for specifying a resource required by each application for processing.

In the MFP 100 according to the present embodiment, a resource is assumed to be a hardware device included in the MFP 100. When each application uses a specified resource, a process is requested to a lower-layer application that controls the resource.

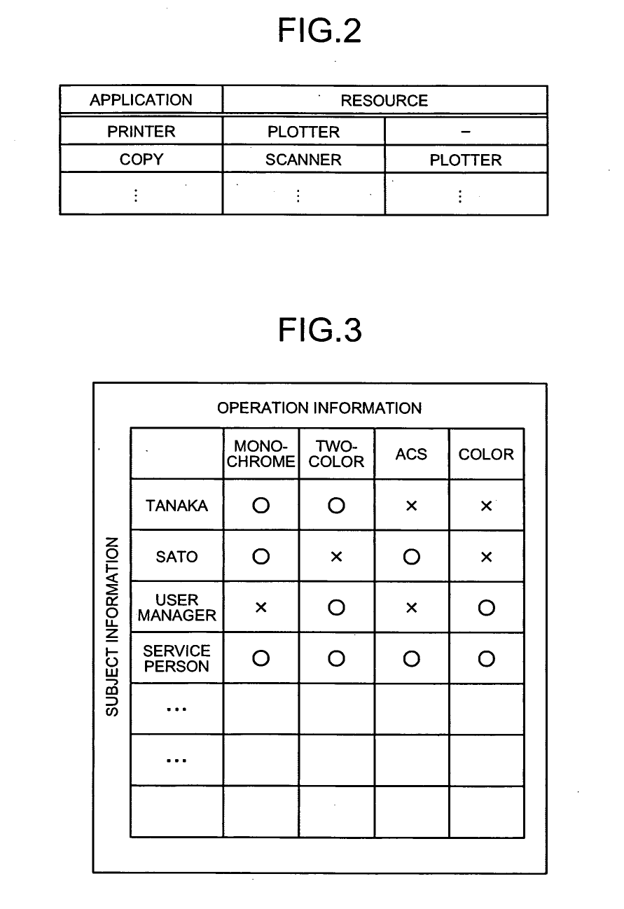

FIG. 2 is a drawing of a table structure of the corresponding resource management table 113. As depicted in FIG. 2, the corresponding resource management table 113 has held therein applications in the application layer 103 and resources in the application shared service layer 104 in association with each other. With this, a resource required by the application for executing a process can be specified.

Also, when a request for executing a process, operation information, and the user name identifying the user that has requested the process are input from the user interface layer 101, an application in the application layer 103 (for example, the copy application 111 or the printer application 112) requests the application control layer 102 to generate a job corresponding to the process. With this, the application control layer 102 collectively manages jobs corresponding to the processes requested to the respective applications.

The application control layer 102 controls each application included in the application layer 103. For example, the application control layer 102 performs job scheduling by using the jobs generated in response to the requests to the respective applications.

The application control layer 102 then makes an instruction for executing each application according to the scheduled jobs. At this time, the application control layer 102 outputs to the application layer 103 the name of the application that performs the process, the operation information, and the user name.

That is, the application control layer 102 collectively manages jobs, which have conventionally been held by the applications. With this, unlike the conventional MFPs, there is no need to make an instruction for discarding jobs held by each application, halting a process by a job, halting a job acceptance, or others, thereby reducing dependence between each application and the framework unit 150. This makes addition or deletion of an application easy.

The application shared service layer 104 includes a scanner application 121 that controls the scanner unit 107 and a plotter application 124 that controls the plotter unit 108. That is, as resources shared by each application in the application layer 103 of the MFP 100, the application shared service layer 104 collectively manages programs that control the respective devices.

In this manner, the function that controls the resource, the function being conventionally held by each application, is shared irrespectively of the application. With this, when a revision is required for a hardware resource, there is not need to make revisions to each application in the application layer 103, thereby reducing dependence between each application and the framework unit 150.

The scanner application 121 is a lower-layer application that includes a scanner authority determining unit 122 and controls the scanner unit 107 included in the MFP 100. Following an instruction from each application in the application layer 103, the scanner application 121 controls the scanner unit 107.

The scanner authority determining unit 122 includes a scanner authority setting table 123. Upon acceptance of a request for using the scanner unit 107 from each application in the application layer 103, the scanner authority determining unit 122 determines whether the user has authority to use the scanner unit 107. When it is determined from the scanner authority setting table 123 that the user has the authority, the scanner application 121 controls the scanner unit 107.

FIG. 3 is a drawing of an example of a table structure of the scanner authority setting table 123. As depicted in FIG. 3, the scanner authority setting table 123 has held therein, for each piece of subject information (for example, a user identification (ID) of a user or a role set for each user), information as to whether the user has authority for each piece of operation information at the time of executing the scanner unit 107. Here, in FIG. 3, a circle indicates that the user has the authority to execute, whilst a cross indicates that the user does not have the authority to execute.

When each application in the application layer 103 uses the scanner unit 107, the execution request output from the application to the scanner application 121 includes subject information and operation information. Therefore, it is possible to determine whether the user has the authority to execute.

The plotter application 124 is a lower-layer application that includes a plotter authority determining unit 125 and controls the plotter unit 108 included in the MFP 100. Following an instruction from each application in the application layer 103, the plotter application 124 controls the plotter unit 108. Here, the plotter authority determining unit 125 determines whether the user has authority in a procedure similar to that of the scanner authority determining unit 122, and therefore its explanation is omitted herein.

The shared mechanism 105 is executed first upon power-up of the MFP 100, starting the OS 106, the user interface layer 101, the application control layer 102, the application layer 103, and the application shared service layer 104, which will be explained further below. For example, the shared mechanism 105 reads these software programs from a flash memory not shown, and then transfers each of the read programs to a memory area allocated on a Static Random Access Memory (SRAM) or a Synchronous Dynamic Random Access Memory (SDRAM) for start.

Also, the shared mechanism 105 performs exception handling and monitoring for the user interface layer 101, the application control layer 102, the application layer 103, and the application shared service layer 104.

The OS 106 is an operating system, such as UNIX (registered trademark), concurrently executing, as a process, each application included in the application layer 103 or each piece of software stored in the shared mechanism 105, the user interface layer 101, the application control layer 102, or the application shared service layer 104.

In the MFP 100 according to the present embodiment, an internal process and an external process for the applications are separated, with the application control layer 102 as an application control portion and the application shared service layer 104 as a shared service portion for the applications.

Also, with the configuration of the MFP 100 according to the present embodiment, portions to be implemented in an application can be reduced. Also, the MFP 100 can be configured so that addition or deletion of an application does not affect the framework. Therefore, in the MFP 100, addition or deletion of various applications, such as scanning, printing, and receiving applications, can be easily achieved.

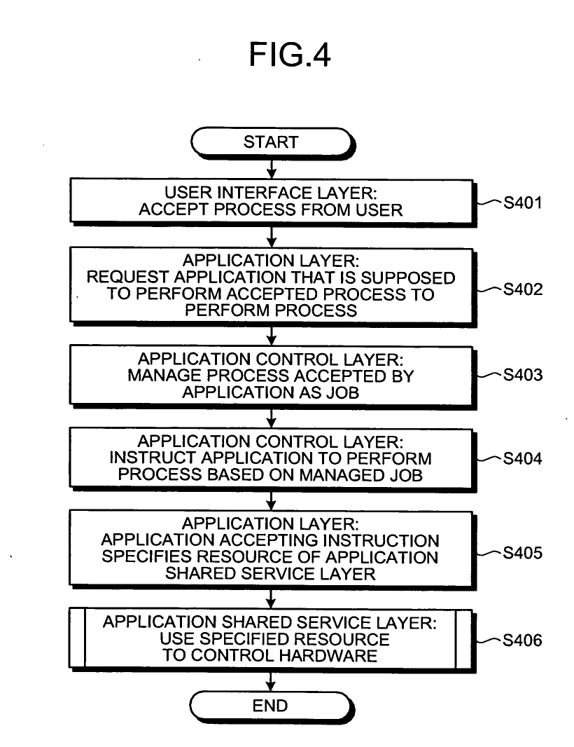

Next, a procedure until an application of the MFP 100 according to the present embodiment configured as explained above executes a process is explained. FIG. 4 is a flowchart of the procedure in the MFP 100 according to the present embodiment.

First, the user interface layer 101 accepts from the user a process to be executed by the MFP 100 (step S401).

Next, in the application layer 103, a request for a process is made from the user interface layer 101 to an application that is supposed to execute the accepted process (step S402).

The application control layer 102 then manages, as a job, the process accepted by the application that has requested the process (step S403).

Next, the application control layer 102 instructs the application to execute the process, based on the managed job (step S404).

Then, in the application layer 103, the application accepting the instruction specifies the resource of the application shared service layer 104 required for the process (step S405).

Next, in the application shared service layer 104, upon an execution request from the application, the specified resource is used to control hardware (step S406). In the application shared service layer 104 according to the present embodiment, when hardware control is performed, whether the user has the authority to use the resource is determined.

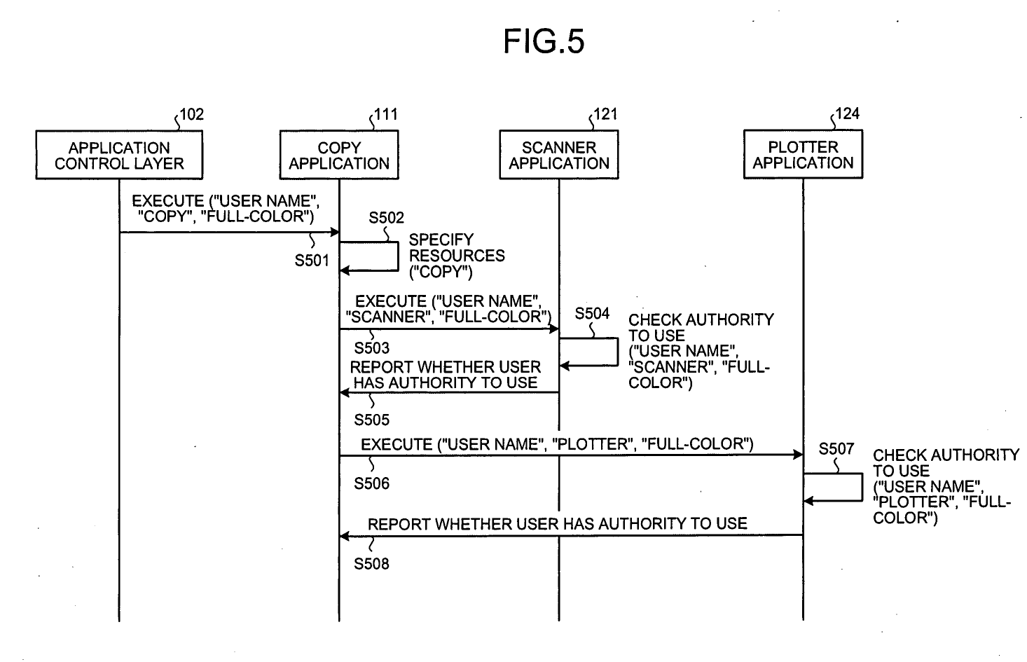

Next, information transmitted and received in the processes at steps S404 to S406 is explained. FIG. 5 is a sequence diagram of an execution procedure when an instruction for executing a copy process is issued from the application control layer 102.

First, the application control layer 102 instructs the copy application 111 to execute a copy process (step S501). At this time, information to be transmitted from the application control layer 102 to the copy application 111 is assumed to be “execute (“user name (subject information)”, “copy”, “full-color”)”. That is, the information includes the user name of the user requesting the process, the requested process (copy), and the operation information for the process (full-color).

The copy application 111 then specifies a resource required for control by using the corresponding resource management table 113 (step S502). It is assumed in this procedure that the scanner unit 107 and the plotter unit 108 are specified as resources required for copy. The copy application 111 then requests the scanner application 121 that controls the scanner unit 107 and the plotter application 124 that controls the plotter unit 108 for control.

Next, the copy application 111 instructs the scanner application 121 to execute a scanner process (step S503). At this time, information to be transmitted from the copy application 111 to the scanner application 121 is assumed to be “execute (“user name (subject information)”, “scanner”, “full-color”)”.

The scanner application 121 then determines based on the input information whether the user has authority to use (step S504). It is assumed in this execution procedure that it is determined that the user has authority to use.

Next, the scanner application 121 reports the use authority determination result to the copy application 111 (step S505). When this report of the determination result indicates that the user has authority to use, the copy application 111 executes a scan process by using the scanner application 121.

Next, the copy application 111 instructs the plotter application 124 to execute a print process (step S506). At this time, information to be transmitted from the copy application 111 to the plotter application 124 is assumed to be “execute (“user name (subject information)”, “plotter”, “full-color”)”.

The plotter application 124 then determines based on the input information whether the user has authority to use (step S507). Here, the authority determination procedure is similar to that of the scanner application 121, and therefore is not explained.

Next, the plotter application 124 reports the use authority determination result to the copy application 111 (step S508). When this report of the determination result indicates that the user has authority to use, the copy application 111 executes a printer process by using the plotter application 124.

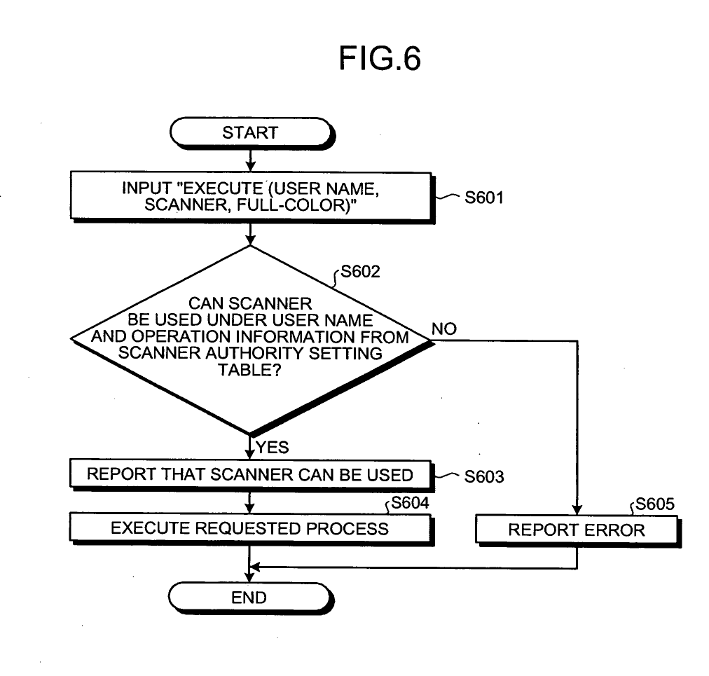

As explained above, in the lower-layer application of the application shared service layer 104, an authority determination process is performed. Next, the authority determination process performed by the scanner application 121 of the application shared service layer 104 is explained. FIG. 6 is a flowchart of a procedure of a process of determining authority performed at the scanner application 121 according to the present embodiment.

First, the scanner application 121 inputs information indicative of an instruction for execution of a process from an application (for example, the copy application 111) (step S601). Here, information to be input is assumed to be “execute (user name, scanner, full-color)”.

Next, the scanner authority determining unit 122 determines from the scanner authority setting table 123 whether the scanner can be used under the input user name (subject information) and operation information (step S602).

When the scanner authority determining unit 122 determines that the scanner cannot be used (“No” at step S602), the scanner application 121 reports error to the application (for example, the copy application 111) (step S605).

On the other hand, when the scanner authority determining unit 122 determines that the scanner can be used (“Yes” at step S602), the scanner application 121 reports to the application (for example, the copy application 111) that the scanner can be used (step S603). The scanner application 121 then executes the process according to the request from the application (step S604).

In the present embodiment, the subjects to be determined as to authority to use is not restricted to the plotter unit 108 and the scanner unit 107 but also can be various hardware resources. Furthermore, the subjects to be determined as to authority to use may be resources other than hardware resources.

In the present embodiment, access control is made at the application shared service layer 104, thereby controlling access to the resources (the plotter unit 108 and the scanner unit 107) even without settings for each application. Furthermore, bypassing access control by an application customized by the user in an unauthorized manner can be prevented.

Still further, according to the MFP 100 of the present embodiment, when an arbitrary user is desired to be inhibited from executing a process (for example, copy or print) with predetermined operation information (for example, full-color), the process with the predetermined operation information can be inhibited by changing only the authority to use the resource that performs the process (for example, the plotter application 124), irrespectively of the application, thereby achieving easy settings. With this, compared with the conventional case of determining the authority for each application, complicated settings for each application are not required, thereby reducing setting errors.

In the first embodiment, a determination whether the user has authority to use is made not restrictively at the application shared service layer. Thus, in a second embodiment, such a determination as to authority is made also at the application layer.

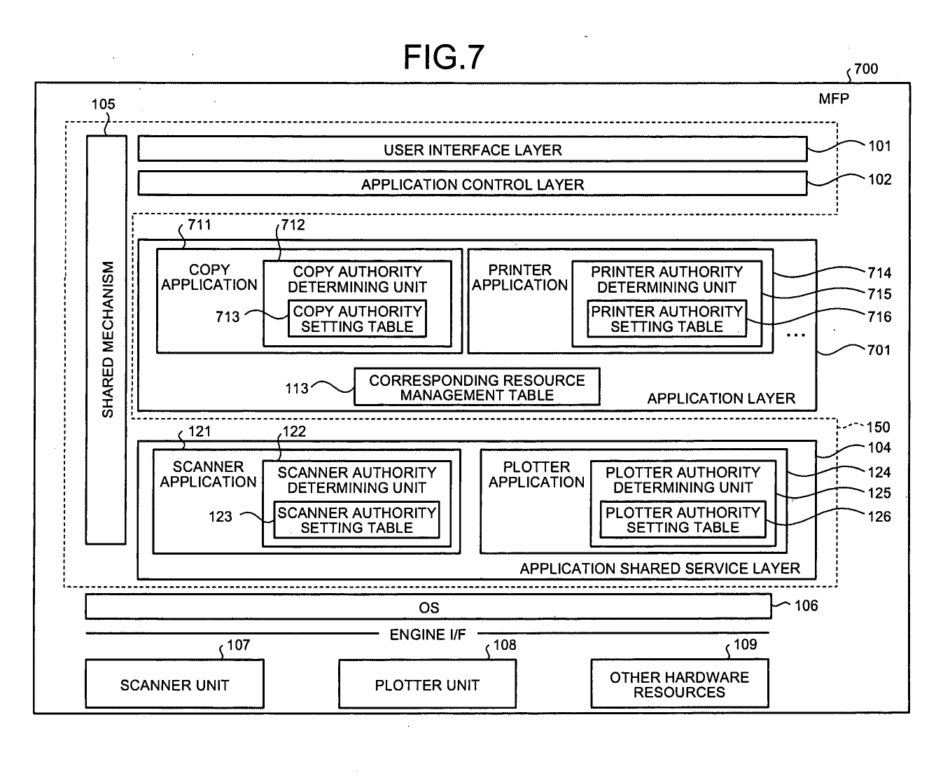

FIG. 7 is a block diagram of the configuration of an MFP 700 according to the second embodiment. The MFP 700 is different from the MFP 100 according to the first embodiment in that the application layer 103 is changed to an application layer 701 that performs a different process. In the following explanation, components identical to those in the first embodiment are provided with the same reference numerals, and are not explained herein.

The application layer 701 is different from the application layer 103 in that the copy application 111 is changed to a copy application 711 that performs a different process and the printer application 112 is changed to a printer application 714 that performs a different process.

The copy application 711 is an application that includes a copy authority determining unit 712 and executes a copy process, which is a function of the MFP 700, when an instruction from the application control layer 102 is input the copy application 711 executes the copy process.

The copy authority determining unit 712 includes a copy authority setting table 713 and, when an instruction for executing a copy process is input from the application control layer 102, determines whether the user has authority to copy with the user-set operation information. Also, the copy authority determining unit 712 uses the copy authority setting table 713 to determine whether the user has the authority.

As with the scanner authority setting table 123 depicted in FIG. 3, the copy authority setting table 713 has held therein, for each piece of subject information, information as to whether the user has authority to execute for each piece of operation information.

The printer application 714 includes an application that includes a printer authority determining unit 715 and executes a print process, which is a function of the MFP 700, when an instruction for execution from the application control layer 102 is input.

The printer authority determining unit 715 includes a printer authority setting table 716 and, when an instruction for executing a print process is input from the application control layer 102, determines whether the user has authority to print with the user-set operation information. Also, the printer authority determining unit 715 uses the printer authority setting table 716 to determine whether the user has the authority.

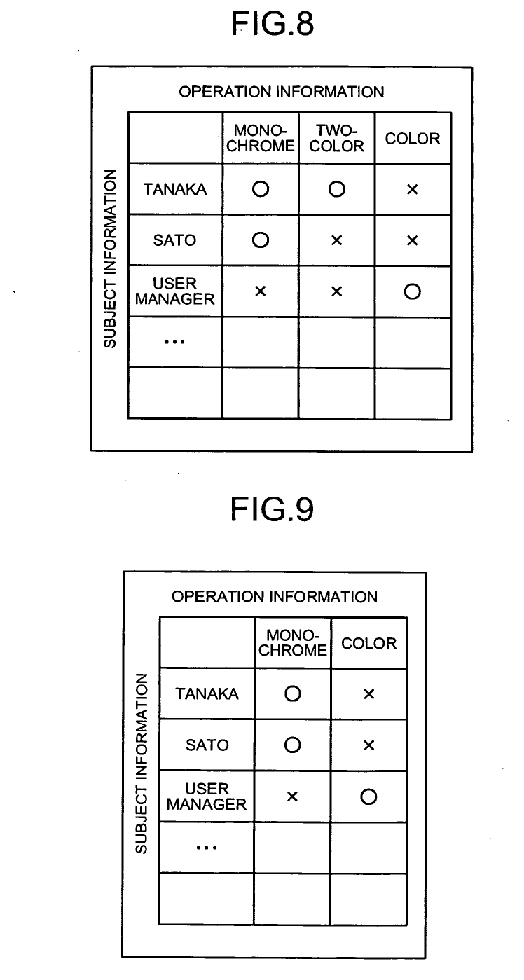

As with the scanner authority setting table 123 depicted in FIG. 3, the printer authority setting table 716 has held therein, for each piece of subject information, information as to whether the user has authority to execute for each piece of operation information. FIG. 8 is a drawing of an example of a table structure of the printer authority setting table 716. As depicted in FIG. 8, in the operation information of the printer authority setting table 716, three items are set, that is, “monochrome”, “two-color”, and “color”.

The scanner application 121 and the plotter application 124 are similar to those in the first embodiment. These scanner application 121 and plotter application 124 determine, whether the user has authority to use with the set operation information when an instruction for execution is accepted from the application in the application layer 103.

FIG. 9 is a drawing of a table structure of a plotter authority setting table 126. As depicted in FIG. 9, the plotter authority setting table 126 has held therein, for each piece of subject information, information as to whether the user has authority for each piece of operation information at the time of executing the plotter unit 108. As depicted in FIG. 9, in the operation information of the plotter authority setting table 126, two items are set, that is, “monochrome” and “color”.

In the MFP according to the present embodiment, the printer application 714 and the plotter application 124 determines whether the user has authority to perform the process with the operation information, thereby allowing multi-level authority check.

Also, settable items are different between the operation information of the printer authority setting table 716 of FIG. 8 and the operation information of the plotter authority setting table 126 of FIG. 9. That is, while the plotter application 124 can not determine whether the user has authority for two types of operation information, the printer application 714 can determine whether the user has authority for three types of operation information including “two-color”. That is, the MFP 700 allows authority check with different granularities in a stepwise manner.

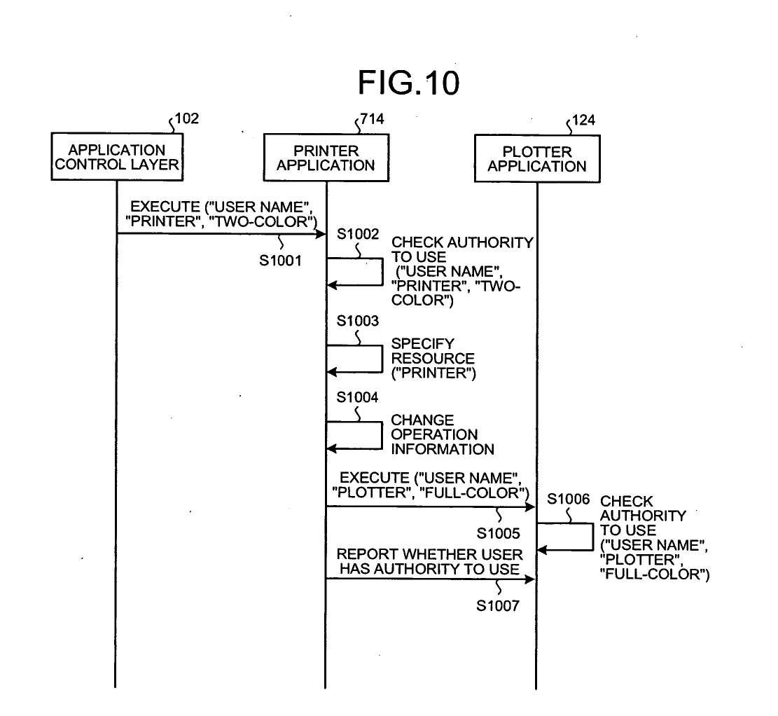

Next, a print process when an input indicative of two-color printing is accepted from the user is explained. FIG. 10 is a sequence diagram of an execution procedure when an instruction for executing a two-color print process from the application control layer 102.

First, the application control layer 102 instructs the printer application 714 to execute a printer process (step S1001). At this time, information to be transmitted from the application control layer 102 to the copy application 111 is assumed to be “execute (“user name (subject information”, “printer”, “two-color”)”. That is, the information includes the user name of the user requesting the process, the requested process (print), and the operation information for the process (two-color).

The printer application 714 determines based on the input information whether the user has an authority to use (step S1002). Here, a determination method of the authority is explained below. It is assumed in this execution procedure that it is determined that the user has authority to use. When it is determined that the user does not have authority to use, processes at step S1303 and onward are not performed.

The printer application 714 then specifies a resource required for control by using the corresponding resource management table 113 (step S1003). It is assumed in this procedure that the plotter unit 108 is specified as a resource required for print. The printer application 714 then requests the plotter application 124 for control.

The operation information “two-color” based on which it is determined by the printer application 714 that the user has authority to use cannot be recognized by the plotter application 124. Therefore, the printer application 714 changes the operation information “two-color” to operation information “full-color”, which can be recognized by the plotter application 124 and allows the process in “two-color” set by the user (step S1004). With this, by changing the operation information in a stepwise manner, an authority determination according to granularity can be made.

The printer application 714 then instructs the plotter application 124 to execute a print process (step S1005). At this time, information to be transmitted from the printer application 714 to the plotter application 124 is assumed to be “execute (“user name (subject information)”, “plotter”, “full-color”)”.

The plotter application 124 then determines based on the input information whether the user has authority to use (step S1006). It is assumed in this execution procedure that it is determined that the user has authority to use.

Next, the plotter application 124 reports the use authority determination result to the printer application 714 (step S1007). When this report of the determination result indicates that the user has authority to use, the printer application 714 executes a print process by using the plotter application 124.

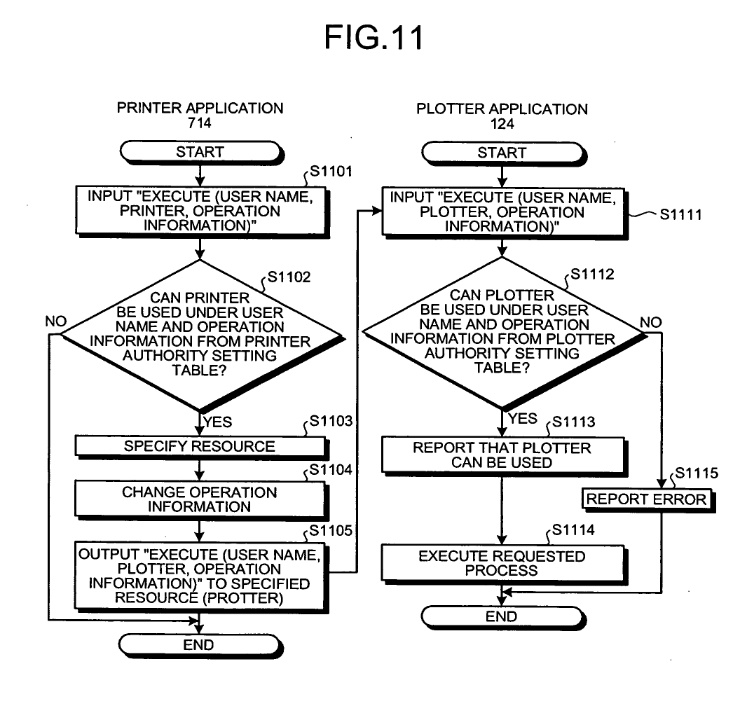

Next, an authority determination process when a “two-color” print process is requested from the user in the MFP 700 is explained. FIG. 11 is a flowchart of a procedure of the process in the MFP 700 according to the present embodiment.

First, the printer application 714 inputs information indicative of an instruction for execution of a process from the application control layer 102 (step S1101). Here, information to be input is assumed to be “execute (user name, printer, operation information (for example, two-color)”.

Next, the printer authority determining unit 715 determines from the printer authority setting table 716 whether the printer can be used under the input user name (subject information) and operation information (step S1102).

The printer authority setting table 716 depicted in FIG. 8 is different from the plotter authority setting table 126 depicted in FIG. 9 in that “two-color” is set in the operation information. Therefore, even when the user sets “two-color” as operation information, a determination as to whether the user has authority to use can be made. This allows an appropriate determination as to whether the user has authority to use according to stepwise granularity for executing the process in the MFP 700.

When the printer authority determining unit 715 determines that the user does not have authority to use (“No” at step S1102), the process ends.

On the other hand, when the printer authority determining unit 715 determines that the user has authority to use (“Yes” at step S1102), a resource for use in the print process is specified from the corresponding resource management table 113 (step S1103). It is assumed in this procedure that the plotter unit 108 is specified.

The printer application 714 then changes the operation information to operation information that can be recognized by the plotter application 124 that controls the specified resource (step S1104). For example, the printer application 714 changes the operation information “two-color” to operation information “full-color”.

Next, the printer application 714 outputs information indicative of an instruction for executing the process to the plotter application 124 that controls the specified resource (step S1105). The information to be output is assumed to be “execute (user name, plotter, operation information (for example, full-color)”. By outputting such information, the process by the plotter application starts.

The plotter application 124 then inputs information indicative of an instruction for executing a process from the printer application 124 (step S1111). The information to be input is assumed to be “execute (user name, plotter, operation information (for example, full-color)”.

Next, the plotter authority determining unit 125 determines from the plotter authority setting table 126 whether the plotter can be used under the input user name (subject information) and operation information (step S1112).

When the plotter authority determining unit 125 determines that the plotter cannot be used (“No” at step S1112), the plotter application 124 reports error to the printer application 714 (step S1115).

On the other hand, when the plotter authority determining unit 125 determines that the plotter can be used (“Yes” at step S1112), the plotter application 124 reports to the printer application 714 that the plotter can be used (step S1113). The plotter application 124 then executes the process according to the request from the printer application 714 (step S1114).

In the MFP 700 according to the present embodiment, access control is performed for each application in the application layer 701, thereby allowing multilevel access control according to access control by the application shared service layer 104. This can inhibit bypassing and achieve access control with fine granularity.

Also, in the second embodiment, various modifications are possible as exemplified below.

### First Modification Example of the Second Embodiment

In the MFP 700 according to the second embodiment, an authority determination is made by the authority determining unit provided inside of each application. In an MFP 1200 according to a first modification example of the second embodiment, an example is explained in which processable operation information and access control is changed by replacing the application in the application layer.

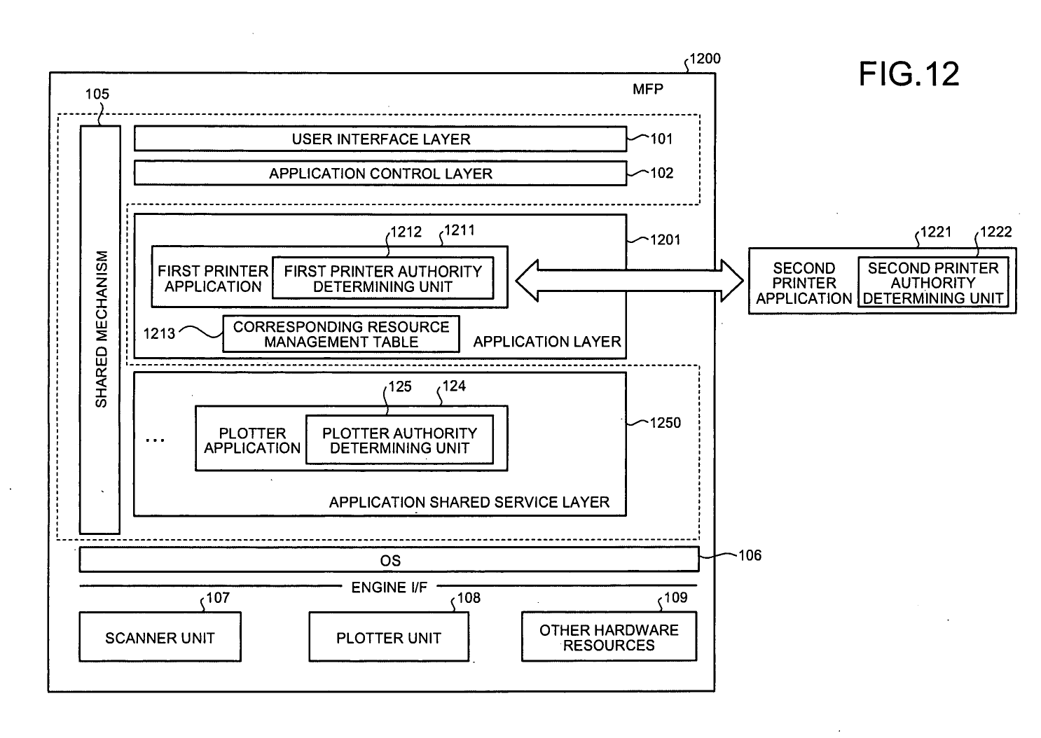

FIG. 12 is a block diagram of the configuration of the MFP 1200 according to the first modification example of the second embodiment. As depicted in FIG. 12, the MFP 1200 is different from the MFP 700 according to the second embodiment in that the application layer 701 is changed to an application layer 1201 having a different configuration. In the following explanation, components identical to those in the second embodiment are provided with the same reference numerals, and are not explained herein. Also not shown, each authority determining unit includes an authority setting table for use in authority determination.

The application layer 1201 includes a first printer application 1211 and a corresponding resource management table 1213. The corresponding resource management table 1213 has held therein the first printer application 1211 and resources of the application shared service layer 104 used in processing by the first printer application 1211 in association with each other.

The first printer application 1211 includes a first printer authority determining unit 1212, providing “monochrome” printing and “full-color” printing as functions. The first printer authority determining unit 1212 determines for each user whether the user has authority to use under the operation information “monochrome” and “full-color”.

To this MFP 1200, the first printer application 1211 is replaced by a second printer application 1221.

The second printer application 1221 includes a second printer authority determining unit 1222, providing “monochrome” printing, “two-color” printing, and “full-color” printing as functions. The second printer authority determining unit 1222 determines for each user whether the user has authority to use under the operation information “monochrome”, “two-color”, and full-color”.

In a replacement procedure, the first printer application 1211 is replaced by the second printer application 1221, and also the corresponding resource management table 1213 is updated correspondingly to the second printer application 1221.

In the present modification example, since the authority determining unit is stored in each application, only with application replacement, access control (determination as to whether the user has authority to use) according to the functions provided by the application can be made.

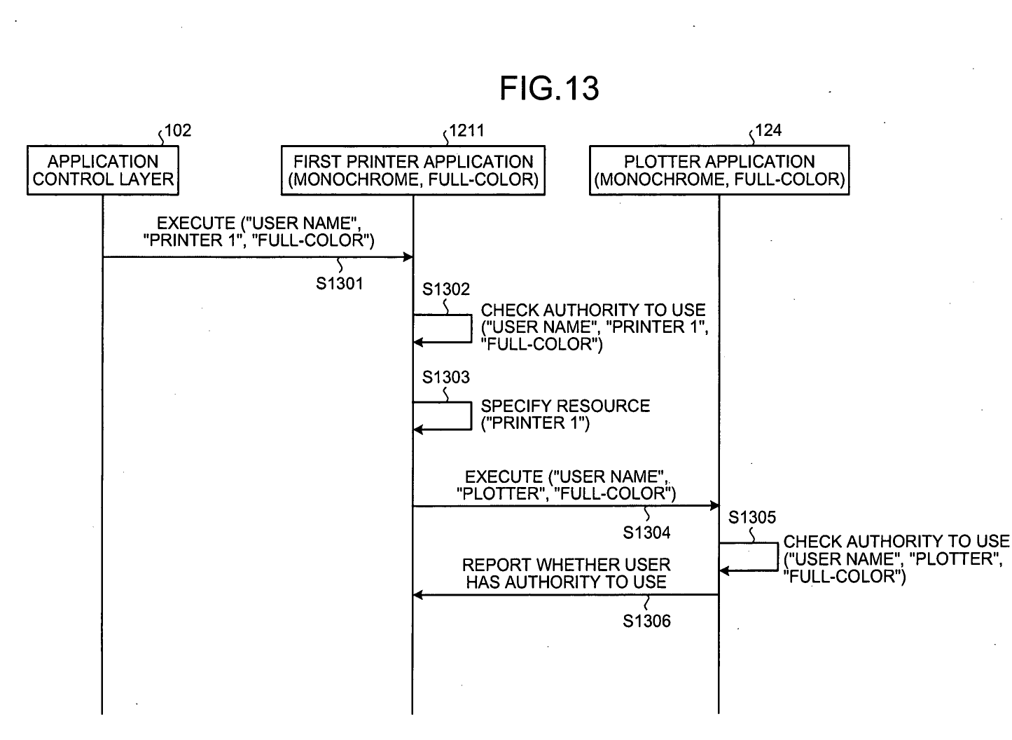

Next, a print process when an input indicative of two-color printing is accepted from the user is explained. FIG. 13 is a sequence diagram of an execution procedure when an instruction for executing a print process is issued from the application control layer 102. Here, it is assumed in the process depicted in FIG. 13 that the user desires to print in two-color but full-color is selected because two-color cannot be set.

First, the application control layer 102 instructs the first printer application 1211 to execute a printer process (step S1301). At this time, information to be transmitted from the application control layer 102 to the copy application 111 is assumed to be “execute (“user name (subject information)”, “printer 1”, “full-color”)”.

The first printer application 1211 then determines based on the input information whether the user has authority to use (step S1302). Here, an authority determination scheme is similar to that according to the second embodiment, and therefore is not explained herein. Here, it is assumed in the execution procedure that it is determined that the user has authority to use. When it is determined that the user does not have authority to use, processes at step S1303 and onward are not performed.

Next, the first printer application 1211 specifies a resource required for control by using the corresponding resource management table 1213 (step S1303). It is assumed in this procedure that the plotter unit 108 is specified as a resources required for print. The first printer application 1211 then requests the plotter application 124 for control.

Then, steps S1304 to S1306 are similar to steps S1005 to S1007, in which the plotter application 124 determines whether the user has authority to use, which are not explained herein.

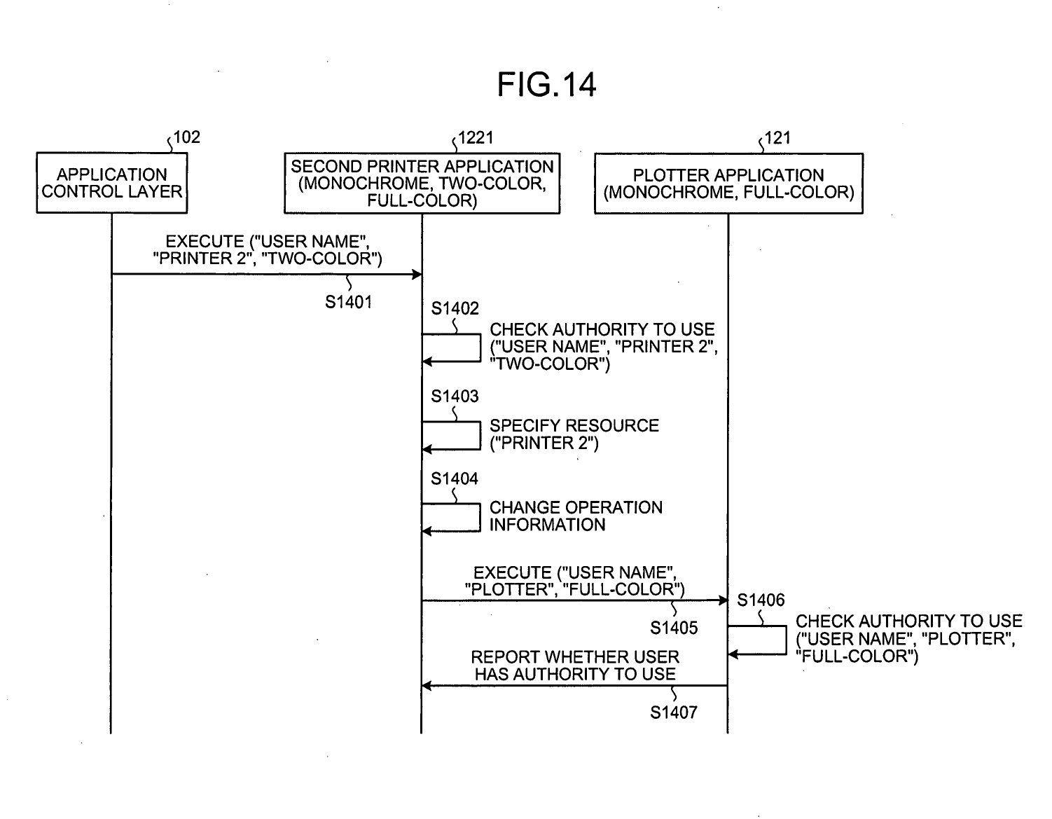

Next, a print process performed after the first printer application 1211 is replaced by the second printer application 1221 is explained. FIG. 14 is a sequence diagram of an execution procedure when an instruction for executing a print process is issued from the application control layer 102. Here in the process depicted in FIG. 14, with the function of the second printer application 1221 after replacement, the user can accept two-color printing.

First, the application control layer 102 instructs the second printer application 1221 to execute a printer process (step S1401). At this time, information to be transmitted from the application control layer 102 to the second printer application 1221 is assumed to be “execute (“user name (subject information)”, “printer 2”, “two-color”)”.

The second printer application 1221 then determines based on the input information whether the user has authority to use (step S1402). Here, an authority determination scheme is similar to that according to the second embodiment, and therefore is not explained herein. It is also assumed in this execution procedure that it is determined that the user has authority to use. When it is determined that the user does not have authority to use, processes at step S1303 and onward are not performed.

Next, the second printer application 1221 specifies a resource required for control by using the corresponding resource management table 1213 (step S1403). It is assumed in this procedure that the plotter unit 108 is specified as a resource required for print.

The second printer application 1221 changes the operation information “two-color” to operation information “full-color” that can be recognized by the plotter application 124 (step S1404). The second printer application 1221 then requests the plotter application 124 for control.

Then, steps S1405 to S1407 are similar to steps S1005 to S1007, in which the plotter application 124 determines whether the user has authority to use, which are not explained herein.

In the present modification example, the first printer application 1211 is replaced by the second printer application 1221 at the application layer 1201 of the MFP 1200. With this, the function at the time of printing is changed. Also, a determination as to access control suitable for the function change (as to whether the user has authority to use the changed function) can be made.

That is, in the MFP 1200, when application replacement occurs, access control suitable for the application after replacement can be made without awareness, thereby reducing workload associated with application replacement.

Also, in the MFP 1200 according to the present modification example, with application replacement, the access control itself can be customized.

### Second Modification Example of the Second Embodiment

In the MFP 700 according to the second embodiment, the authority determining unit of each application uses the authority setting table inside of each application to determine whether the user has authority to use. In the second embodiment, however, the authority setting table is not restricted to be provided inside of the application. Thus, in a second modification example of the second embodiment, an example of collectively managing authority setting tables is explained.

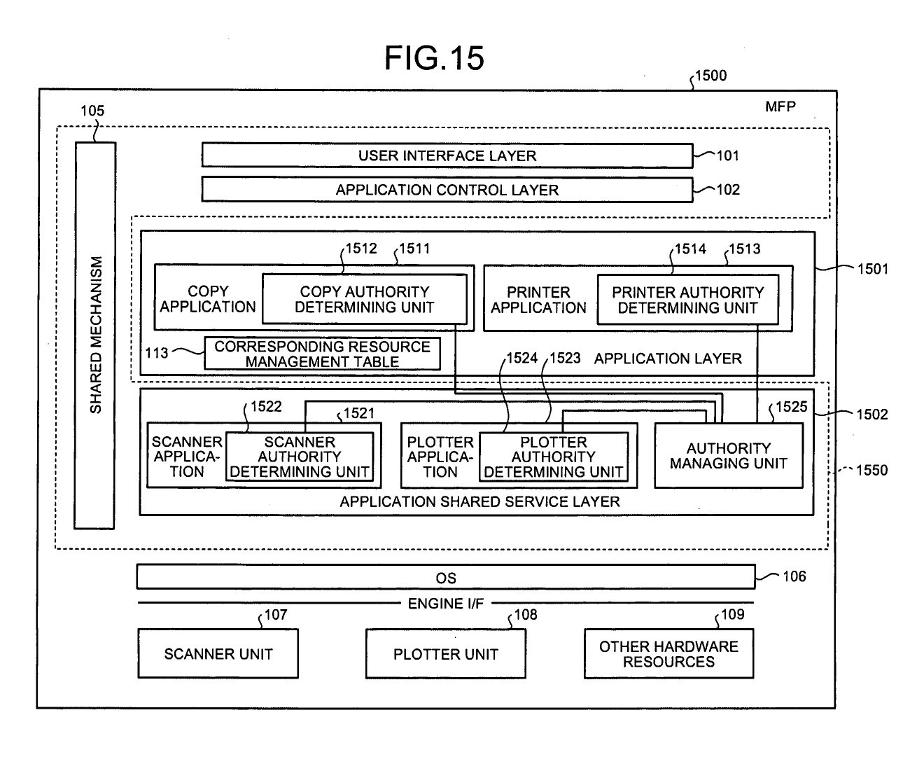

FIG. 15 is a block diagram of the configuration of an MFP 1500 according to the second modification example of the second embodiment. As depicted in FIG. 15, the MFP 1500 is different from the MFP 700 according to the second embodiment in that the application layer 701 is changed to an application layer 1501 having a different configuration and the application shared service layer 104 is changed to an application shared service layer 1502 having a different configuration. In the following explanation, components identical to those in the second embodiment are provided with the same reference numerals, and are not explained herein. As such, in the MFP 1500 according to the present modification example, the framework unit 150 is also changed to a framework unit 1550, as with the case of the application layer 1501.

The application shared service layer 1502 includes a scanner application 1521, a plotter application 1523, and an authority managing unit 1525.

The authority managing unit 1525 collectively manages the authority setting tables provided in the second embodiment for each application. Here, an authority setting table is not restricted to be provided for each application as explained above. Thus, it is assumed in the present modification example that an authority setting table is provided for each user.

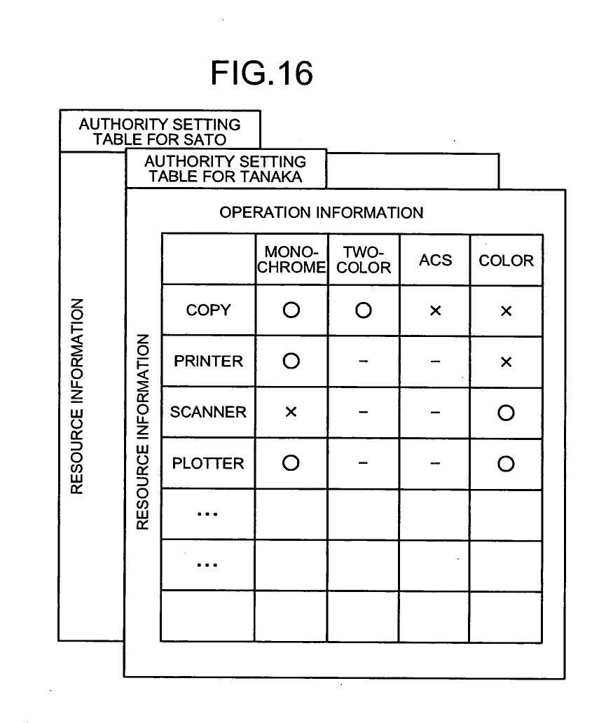

FIG. 16 is a drawing of an example of a table structure of an authority setting table included in the authority managing unit 1525. As depicted in FIG. 16, the authority managing unit 1525 has held therein, in each authority setting table provided for each user, information as to whether the user has authority to use under each piece of operation information for each piece of resource information. It is assumed herein that the resource information is information that identifies a resource or the like included in the MFP 1500.

Referring back to FIG. 15, the scanner application 1521 includes a scanner authority determining unit 1522, and controls the scanner unit 107 by following an instruction from an application in the application layer 1501.

The scanner authority determining unit 1522 determines whether the scanner unit 107 can be used under the operation information input by the user when a request for using the scanner unit 107 is accepted from an application of the application layer 1501. Also, at the time of such a determination, the scanner authority determining unit 1522 obtains from the authority managing unit 1525 information about an authority setting table required for authority determination. With this, the scanner authority determining unit 1522 can determine whether the scanner unit 107 can be used under the operation information input by the user.

The plotter application 1523 includes a plotter authority determining unit 1524, and controls the plotter unit 108 by following an instruction from an application of the application layer 1501.

The plotter authority determining unit 1524 determines whether the scanner unit 107 can be used under the operation information input by the user when a request for using the plotter unit 108 is accepted from an application of the application layer 1501. Also, at the time of such a determination, the plotter authority determining unit 1524 obtains from the authority managing unit 1525 information about an authority setting table required for authority determination. With this, the plotter authority determining unit 1524 can determine whether the plotter unit 108 can be used under the operation information input by the user.

The application layer 1501 includes a copy application 1511 and a printer application 1513.

The copy application 1511 includes a copy authority determining unit 1512, and executes a copy process by following an instruction from the application control layer 102.

The copy authority determining unit 1512 determines whether the user has authority to use a copy process under the operation information input by the user. Also, at the time of such a determination, the copy authority determining unit 1512 obtains from the authority managing unit 1525 information about an authority setting table required for authority determination. With this, the copy authority determining unit 1512 can determine whether copying can be used under the operation information input by the user.

The printer application 1513 includes a printer authority determining unit 1514, and executes a copy process by following an instruction from the application control layer 102.

The printer authority determining unit 1514 determines whether a printer process can be used under the operation information input by the user. Also, at the time of such a determination, the printer authority determining unit 1514 obtains from the authority managing unit 1525 information about an authority setting table required for authority determination. With this, the printer authority determining unit 1514 can determine whether the printer can be used under the operation information input by the user.

Furthermore, in the MFP 1500 according to the present modification example, the authority setting tables for the respective applications or respective resources are collectively managed by the authority managing unit 1525. Therefore, when a revision is required, there is no need to make a revision for each application or resource, thereby reducing workload for management.

Still further, in the MFP 1500 according to the present modification example, as the authority setting tables in the authority managing unit 1525, tables not with a resource name (copy or printer) but with a subject name (Mr./Ms. Tanaka, Mr./Ms. Suzuki) as a key are used. With this, when a user is added or deleted, the settings can be changed only by adding or deleting one table, thereby reducing workload of the manager. Still further, when a table is provided for each piece of resource information, a plurality of resource tables have to be simultaneously changed, and therefore setting errors tend to occur. By contrast, in the present modification example, tables with a subject name as a key are used, thereby reducing such setting errors.

### Third Modification Example of the Second Embodiment

In the MFP 1200 according to the first modification example of the second embodiment, the example of replacing the application of the application layer 1501 has been explained. However, the subject to be replaced is not restricted to the application in the application layer, the configuration of the framework unit may be replaced. Thus, in a third modification example of the second embodiment, an example of replacing an application of the application shared service layer is explained.

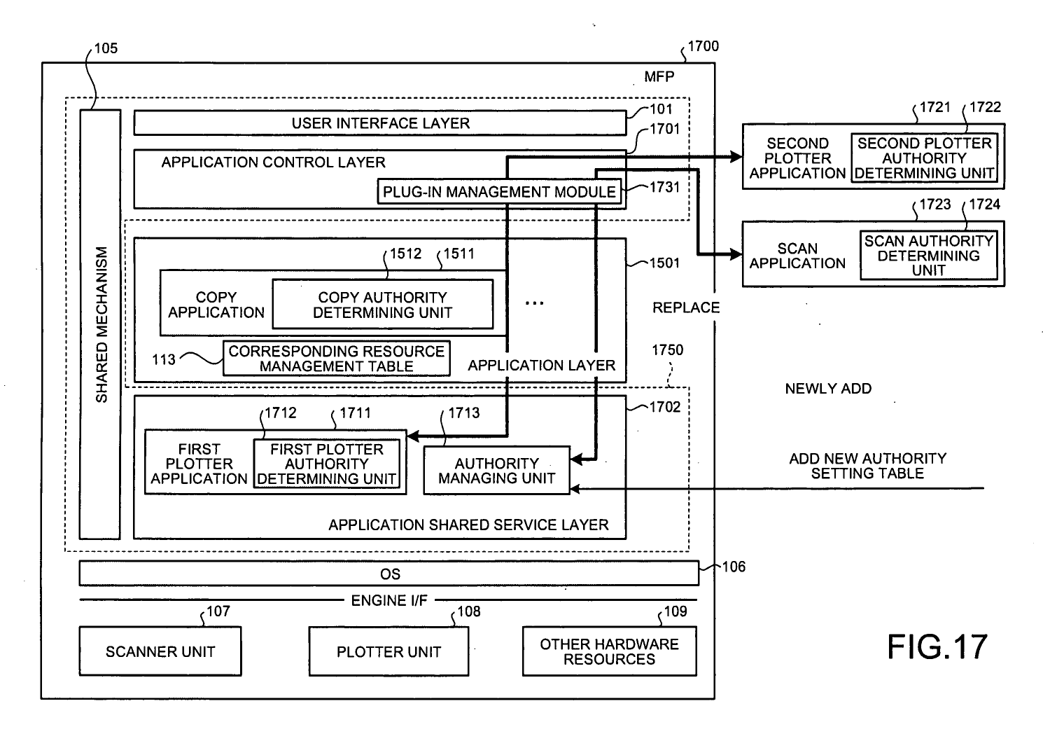

FIG. 17 is a block diagram of the configuration of an MFP 1700 according to the third modification example of the second embodiment. As depicted in FIG. 17, the MFP 1700 is different from the MFP 1500 according to the second modification example of the second embodiment in that the application control layer 102 is changed to an application control layer 1701 having a different configuration and the application shared service layer 1502 is changed to an application shared service layer 1702 having a different configuration from the application shared service layer 104. In the following explanation, components identical to those in the second modification example of the second embodiment are provided with the same reference numerals, and are not explained herein.

The application control layer 1701 includes a plug-in management module 1731. Here, the application control layer 1701 includes functions similar to those of the application control layer 102 except for the plug-in management module 1731, and therefore is not explained herein.

The plug-in management module 1731 manages resources, such as applications included in a framework unit 1750. Through the plug-in management module 1731, a resource of the application shared service layer 1702 is replaced or added.

The application shared service layer 1702 includes a first plotter application 1711 and an authority managing unit 1713. The authority managing unit 1713 includes an authority setting table for each application in the application layer 1501 and an authority setting table for each application (first plotter application 1711) in the application shared service layer 1702.

The first plotter application 1711 includes a first plotter authority determining unit 1712, providing a print function. The first plotter authority determining unit 1712 determines whether the user has authority to use with the input operation information.

To this MFP 1700, the first plotter application 1711 is replaced by a second plotter application 1721, and a scan application 1723 is added.

The second plotter application 1721 includes a second plotter authority determining unit 1722, providing an enhanced print function compared with the function of the first plotter application 1711. The second plotter authority determining unit 1722 determines whether the user has authority to use the operation information in the enhanced print function.

The scan application 1723 includes a scan authority determining unit 1724, providing a scan function. The scan application 1723 determines whether the user has authority to use the operation information in the scan function.

The plug-in management module 1731 replaces the first plotter application 1711 by the second plotter application 1721, and also updates the corresponding resource management table 1213 so that the table corresponds to the second plotter application 1721. Also, when the scan application 1723 is added, the plug-in management module 1731 updates the corresponding resource management table 1213 so as to allow the use of the scan application 1723.

After being stored in the application shared service layer 1702, the second plotter application 1721 and the scan application 1723 each newly add an authority setting table to the authority managing unit 1713. With this by using the added authority setting tables, the second plotter application 1721 and the scan application 1723 can determine whether the user has authority.

As evident from the modification example, a component can be replaced or newly added to the framework unit 1750, such as the application shared service layer 1702. With this, the setting items regarding access control can be easily changed for each resource.

In this manner, by providing the plug-in management module 1731 to allow a component to be replaced or newly added, detailed access control can be achieved in the framework unit 1750 as required.

An MFP according to a third embodiment is configured such that applications forming an application layer have a multilevel structure.

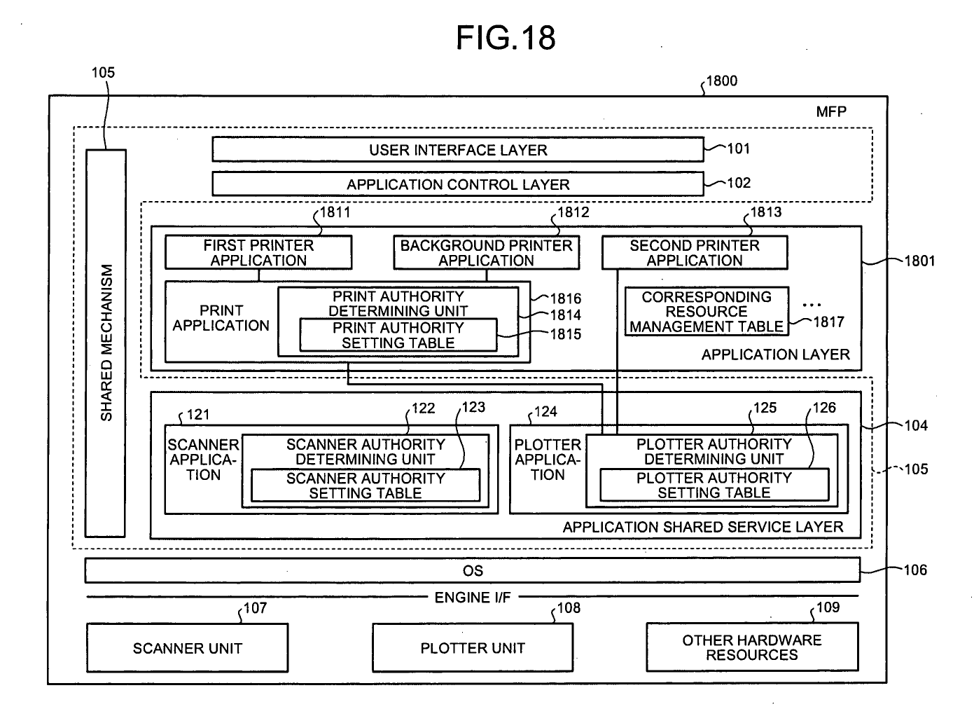

FIG. 18 is a block diagram of the configuration of an MFP 1800 according to the third embodiment. The MFP 1800 is different from the MFP 700 according to the second embodiment in that the application layer 701 is changed to an application layer 1801 that performs a different process. In the following explanation, components identical to those in the second embodiment are provided with the same reference numerals, and are not explained herein.

The application layer 1801 includes a first printer application 1811, a background printer application 1812, a second printer application 1813, a print application 1814, and a corresponding resource management table 1817.

The first printer application 1811 is an application that performs a print process at the MFP 1800, instructing the print application 1814, which will be explained further below, to execute a print process when an instruction for execution is input from the application control layer 102.

The background printer application 1812 is an application that performs a print process by embedding a background in the MFP 1800, instructing the print application 1814, which will be explained further below, to execute a print process by embedding a background when an instruction for execution is input from the application control layer 102.

The second printer application 1813 is an application that performs a print process with a function different from that of the first printer application 1811, instructing the plotter application 124 to execute a print process when an instruction for execution is input from the application control layer 102.

The print application 1814 includes a print authority determining unit 1815, and is an application that performs a print process with a function common to the first printer application 1811 and the background printer application 1812. When an instruction for execution is input from the first printer application 1811 or the background printer application 1812, the print application 1814 instructs the plotter application 124 to execute a print process.

The print authority determining unit 1815 includes a print authority setting table 1816. When an instruction for printing is input from the first printer application 1811 or the background printer application 1812, the print authority determining unit 1815 determines whether the user has authority to print with the set operation information. At this time, the print authority determining unit 1815 determines whether the user has authority by using the print authority setting table 1816.

The corresponding resource management table 1817 has held therein applications (the print application 1814 and the second printer application 1813) in the application layer 1801 and resources in the application shared service layer 104 in association with each other.

In this manner, the first printer application 1811 and the background printer application 1812 instructs the plotter application 124 for a print process via the print application 1814, whilst the second printer application 1813 directly instructs the plotter application 124 for a print process.

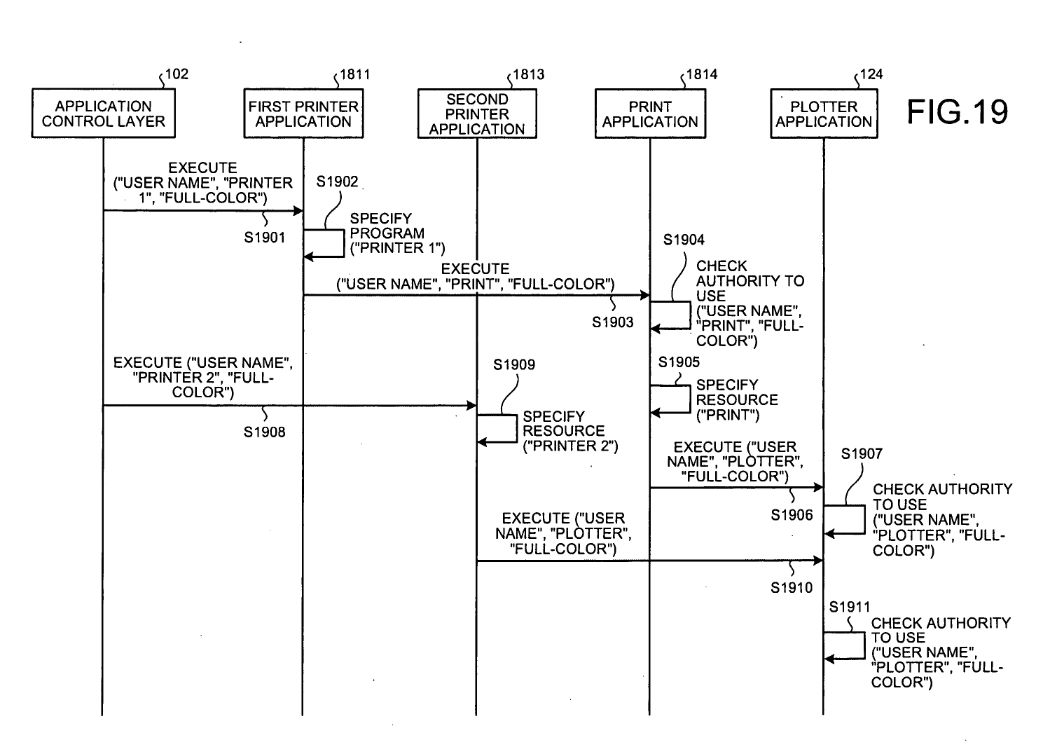

FIG. 19 is a sequence diagram of an execution procedure when an instruction for executing a print process is issued from the application control layer 102. Here, in this execution procedure, it is exemplarily assumed that a print instruction is made from the application control layer 102 to the first printer application 1811 and the second printer application 1813.

First, the application control layer 102 instructs the first printer application 1811 to execute a printer process (step S1901). At this time, information to be transmitted from the application control layer 102 to the first printer application 1811 is assumed to be “execute “user name (subject information)”, “printer 1”, “full-color”)”. That is, the information includes the user name of the user requesting the process, the requested process (printer 1), and the operation information of the process (full-color).

The first printer application 1811 then specifies a program required for control by using the corresponding resource management table 1817 (step S1902). It is assumed in this procedure that the print application 1814 is specified as a required program. The first printer application 1811 then requests the print application 1814 for control

Next, the first printer application 1811 instructs the print application 1814 to execute a print process (step S1903). At this time, information to be transmitted from the first printer application 1811 to the print application 1814 is assumed to be “execute “user name (subject information)”, “print”, “full-color”)”.

The print application 1814 then determines based on the input information whether the user has authority to use (step S1904). This execution procedure is similar to that according to the embodiments explained above, and therefore is not explained herein. Also, it is assumed in this execution procedure that it is determined that the user has authority to use.

Next, the print application 1814 specifies a resource required for control by using the corresponding resource management table 1817 (step S1905). It is assumed in this procedure that the plotter application 124 is specified as a required resource. The print application 1814 then requests the plotter application 124 for control.

Next, the print application 1814 instructs the plotter application 124 to execute a print process (step S1906). At this time, information to be transmitted from the print application 1814 to the plotter application 124 is assumed to be “execute “user name (subject information)”, “plotter”, “full-color”)”.

The plotter application 124 then determines based on the input information whether the user has authority to use (step S1907). This execution procedure is similar to that according to the embodiments explained above, and therefore is not explained herein. Also, it is assumed in this execution procedure that it is determined that the user has authority to use. With this, a report of authority determination is issued from the plotter application 124. As a result, upon an instruction from the first printer application 1811, the plotter unit 108 is started to be controlled.

Next, the application control layer 102 instructs the second printer application 1813 to execute a printer process (step S1908). At this time, information to be transmitted from the application control layer 102 to the second printer application 1813 is assumed to be “execute “user name (subject information)”, “printer 2”, “full-color”)”. That is, the information includes the user name of the user requesting the process, the requested process (printer 2), and the operation information of the process (full-color).

The second printer application 1813 then specifies a program required for control by using the corresponding resource management table 1817 (step S1909). It is assumed in this procedure that the plotter application 124 is specified as a required program. The second printer application 1813 then requests the plotter application 124 for control.

Next, the second printer application 1813 instructs the plotter application 124 to execute a print process (step S1910). At this time, information to be transmitted from the second printer application 1813 to the plotter application 124 is assumed to be “execute “user name (subject information)”, “plotter”, “full-color”)”.

The plotter application 124 then determines based on the input information whether the user has authority to use (step S1911). This execution procedure is similar to that according to the embodiments explained above, and therefore is not explained herein. Also, it is assumed in this execution procedure that it is determined that the user has authority to use. With this, a report of authority determination is issued from the plotter application 124. As a result, upon an instruction from the second printer application 1813, the plotter unit 108 is started to be controlled.

In the MFP 1800 according to the present embodiment, the application layer 1801 has a multilevel configuration. That is, upper customized applications including the first printer application 1811 and the background printer application 1812 and an intermediate customized application including the print application 1814 are provided, wherein the upper customized applications control devices through the intermediate customized application. Also in the MFP 1800 according to the present embodiment, access control is made by the intermediate customized application (print application 1814). With this, access control required for each of the upper customized applications of the first printer application 1811 and the background printer application 1812 can be performed by only one portion, thereby making the settings easy when access control is changed.

In the embodiment explained above, access control is made at the application layer and the application shared service layer. However, access control is not restrictively performed at the application layer or the application shared service layer. In an MFP according to a fourth embodiment, access control is made also at an application control layer.

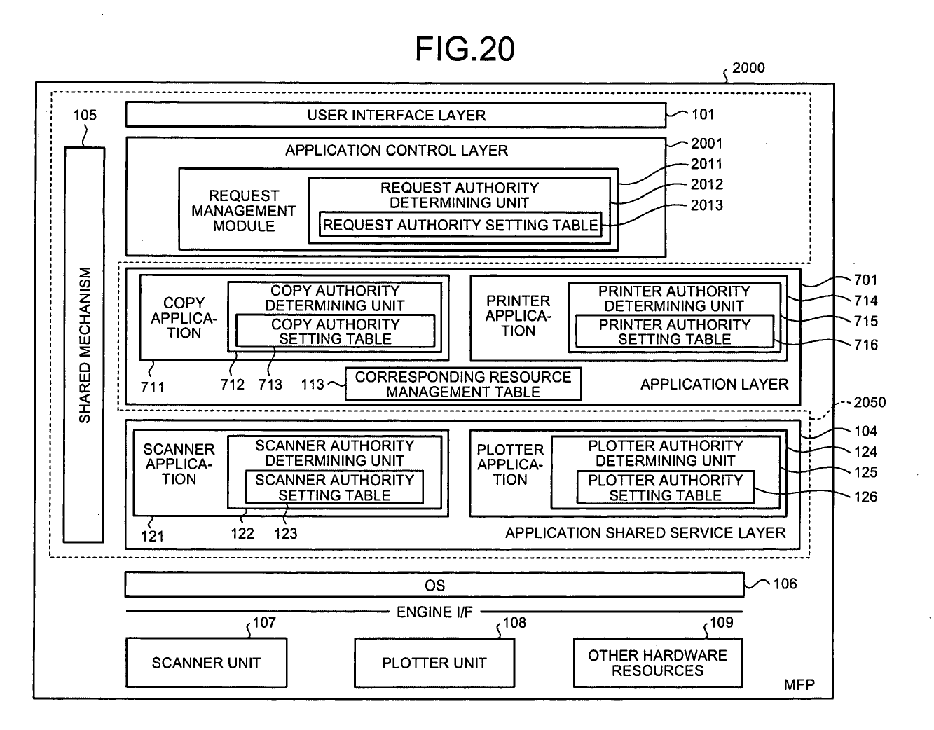

FIG. 20 is a block diagram of the configuration of an MFP 2000 according to the fourth embodiment. The MFP 2000 is different from the MFP 700 according to the second embodiment in that the application control layer 102 is changed to an application control layer 2001 that performs a different process. In the following explanation, components identical to those in the second embodiment are provided with the same reference numerals, and are not explained herein. As such, in the MFP 2000 according to the fourth embodiment, the framework unit 1550 is also changed to a framework unit 2050.

The application control layer 2001 includes a request management module 2011, controlling each application included in the application layer 701.

The request management module 2011 includes a request authority determining unit 2012, managing a job generated according to a request from an application as a request for scheduling processes to be executed.

The request authority determining unit 2012 includes a request authority setting table 2013 and, when a request for generating a job is accepted from an application, determines whether the user has authority to use the application. The request authority setting table 2013 manages, for each user, information as to whether the user has authority to use each application.

As in the MFP 2000 according to the present embodiment, each component can have a multilevel configuration irrespectively of the application layer. With this, in the MFP 2000, access control can be appropriately made according to granularity. Also, access control is made as requested by the manager. With this, authority can be easily set and managed.

As in the MFP 2000, the application control layer 2001 controls an input of a process request to each application in the application layer 701. With this, an attack to vulnerability of each application in the application layer 701 (for example, abusing a printer application 714 or the plotter application 124 with vulnerability) can be avoided. Furthermore, it is possible to address a problem unavoidable by access control of the application shared service layer 104, such as an occupied CPU included in the MFP 2000.

In the embodiment explained above, access control is made for each application in the application layer and the application shared service layer. However, access control is not meant to be restricted to be made for each application in the application layer and the application shared service layer. Thus, in an MFP according to a fifth embodiment, access control is made in a collective manner.

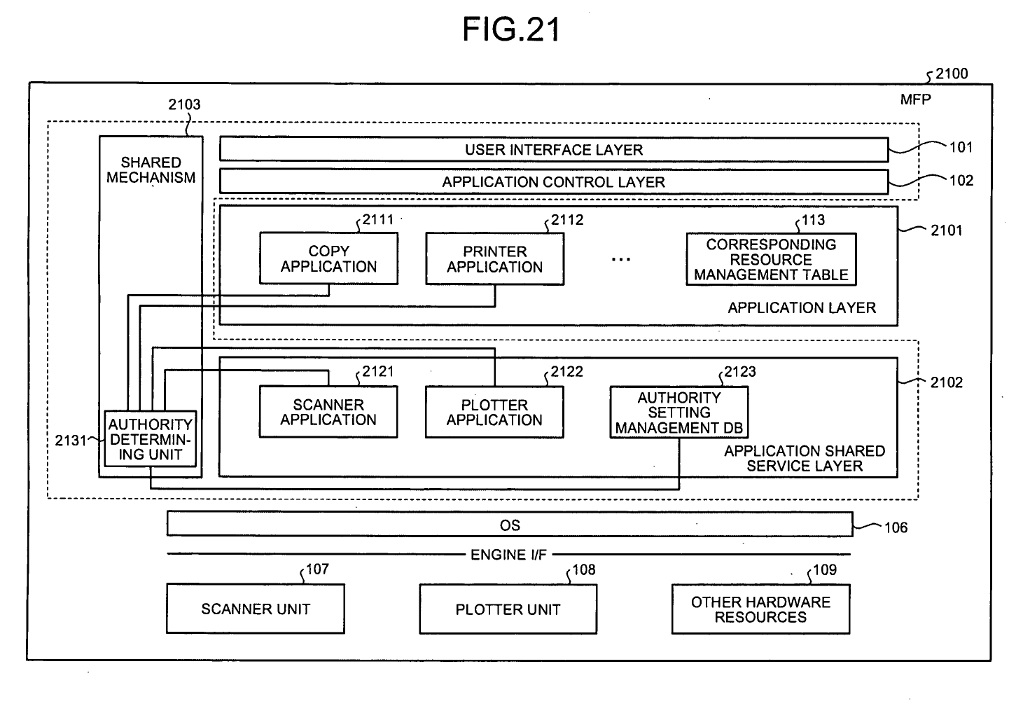

FIG. 21 is a block diagram of the configuration of an MFP 2100 according to the fifth embodiment. The MFP 2100 is different from the MFP 700 according to the second embodiment in that the application layer 701 is changed to an application layer 2101 that performs a different process, the application shared service layer 104 is changed to an application shared service layer 2102 that performs a different process, and the shared mechanism 105 is changed to a shared mechanism 2103 that performs a different process. In the following explanation, components identical to those in the second embodiment are provided with the same reference numerals, and are not explained herein.

The application shared service layer 2102 includes a scanner application 2121, a plotter application 2122, and an authority setting management database (DB) 2123.

The scanner application 2121 is a resource that controls the scanner unit 107 included in the MFP 2100. When an instruction for execution is accepted, the scanner application 2121 outputs resource information indicative of the scanner application 2121, input operation information, and subject information that identifies the user to an authority determining unit 2131, which will be explained further below. When an indication that the user has authority to use is input from the authority determining unit 2131, the scanner application 2121 controls the scanner unit 107.

The plotter application 2122 is a resource that controls the plotter unit 108 included in the MFP 2100. when an instruction for execution is accepted, the plotter application 2122 outputs resource information indicative of the plotter application 2122, input operation information, and subject information that identifies the user to the authority determining unit 2131, which will be explained further below. When an indication that the user has authority to use is input from the authority determining unit 2131, the plotter application 2122 controls the plotter unit 108.

The authority setting management DB 2123 has held therein, for each piece of operation information in each piece of resource information, information as to whether the user has authority to use in association with the subject information. Also, the resource information in the present embodiment is assumed to be information that identifies a resource in the application shared service layer 2102 and an application in the application layer 2101 in the MFP 2100. The information held in the authority setting management DB 2123 is used by the authority determining unit 2131, which will be explained further below.

The application layer 2101 includes a copy application 2111, a printer application 2112, and the corresponding resource management table 113.

When an instruction for execution is accepted, the copy application 2111 outputs resource information indicative of the copy application 2111, input operation information, and subject information that identifies the user to the authority determining unit 2131, which will be explained further below. When an indication that the user has authority to use is input from the authority determining unit 2131, the copy application 2111 instructs the resource for use in copying in the application shared service layer 2102 for execution. Also, other functions of the copy application 2111 are similar to those of the copy application 711 according to the second embodiment, and therefore are not explained herein.

When an instruction for execution is accepted, the printer application 2112 outputs resource information indicative of the printer application 2112, input operation information, and subject information that identifies the user to the authority determining unit 2131, which will be explained further below. When an indication that the user has authority to use is input from the authority determining unit 2131, the printer application 2112 instructs the plotter application 2122 of the application shared service layer 2102 for execution. Other functions of the printer application 2112 are similar to those of the printer application 714 according to the second embodiment, and therefore are not explained herein.

The shared mechanism 2103 includes the authority determining unit 2131 in addition to the functions included in the shared mechanism 105 according to the embodiments explained above.

The authority determining unit 2131 determines, from the resource information (application or resource name), the operation information, and the subject information (user name) input from the application or the like, which will be explained further below, whether the user with the user name has authority to use the resource or program indicated by the resource information under the operation information. Based on the determination result, the authority determining unit 2131 then outputs information indicative of whether the user has authority to use to the application or the like inputting the resource information and others.

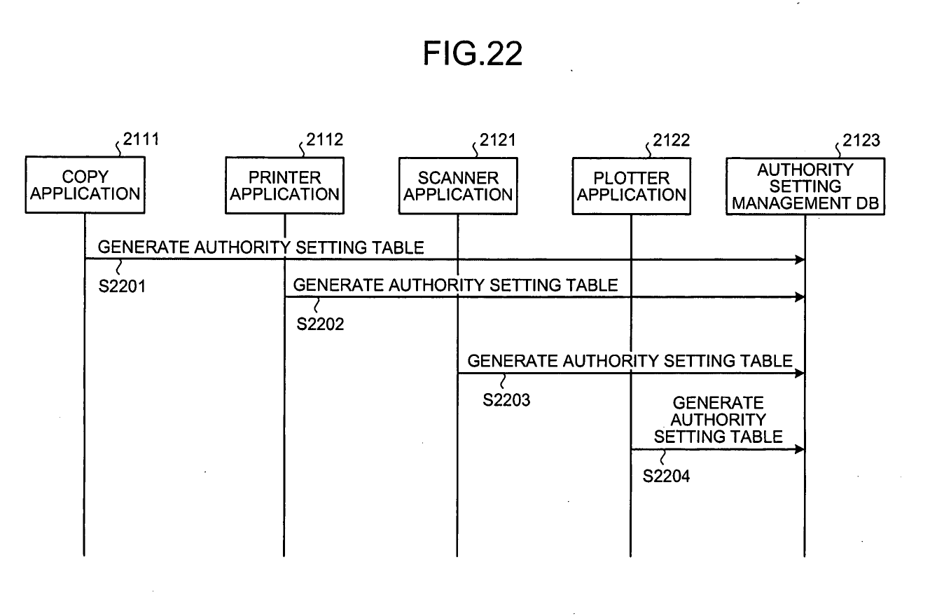

Next, a process required for making an authority determination is explained. FIG. 22 is a sequence diagram of an execution procedure when an instruction for executing a two-color print process is issued from the application control layer 102.

FIG. 22 is a sequence diagram of the execution procedure at the MFP 2100 started after each application and others are installed.

First, in the resource information indicating the copy application 2111, for each piece of settable operation information, the copy application 2111 generates in the authority setting management DB 2123 a copy authority setting table having held therein information indicative of whether the user identified with the subject information can use (step S2201).

Next, in the resource information indicating the printer application 2112, for each piece of settable operation information, the printer application 2112 generates in the authority setting management DB 2123 a printer authority setting table having held therein information indicative of whether the user identified with the subject information can use (step S2202).

Then, in the resource information indicating the scanner application 2121, for each piece of settable operation information, the scanner application 2121 generates in the authority setting management DB 2123 a scanner authority setting table having held therein information indicative of whether the user identified with the subject information can use (step S2203).

Next, in the resource information indicating the plotter application 2122, for each piece of settable operation information, the plotter application 2122 generates in the authority setting management DB 2123 a plotter authority setting table having held therein information indicative of whether the user identified with the subject information can use (step S2204).

With the procedure explained above, the authority setting tables required for authority determination are held in the authority setting management DB 2123. Access control by using the generated authority setting tables is now explained below.

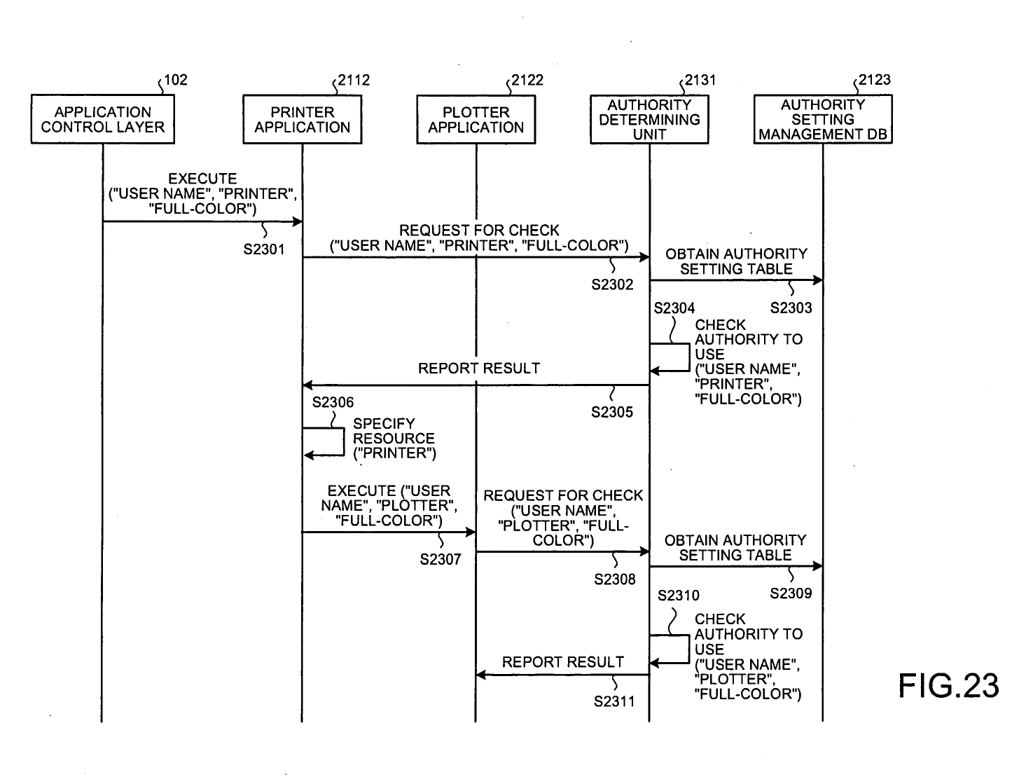

Next, a print process when an input indicative of full-color printing is accepted from the user is explained. FIG. 23 is a sequence diagram of an execution procedure when an instruction for executing a full-color print process is issued from the application control layer 102.

First, the application control layer 102 instructs the printer application 2112 to execute a printer process (step S2301). At this time, information to be transmitted from the application control layer 102 to the printer application 2112 is assumed to be “execute (“user name (subject information)”, “printer”, “full-color”)”. That is, the information includes the user name of the user requesting the process, the requested process (print), and the operation information for the process (full-color).

The printer application 2112 then requests the authority determining unit 2131 for check (step S2302). At this time, the printer application 2112 outputs the user name as the subject information, the “printer” as the resource information, and “full-color” as the operation information to the authority determining unit 2131.

When accepting the request, the authority determining unit 2131 obtains from the authority setting management DB 2133 an authority setting table corresponding to the input resource information and others (step S2303).

The authority determining unit 2131 then determines whether the user identified with the input user name has authority to use the “printer” in “full-color” (step S2304). It is assumed in this execution procedure that the user has authority to use.

Next, the authority determining unit 2131 reports the use authority determination result to the printer application 2112 (step S2305). With this, the printer application 2112 determines that the user has authority to use in “full-color”.

The printer application 2112 then specifies a resource required for control by using the corresponding resource management table 113 (step S2306). It is assumed in this procedure that the plotter unit 108 is specified as a resource required for print. The printer application 2112 then requests the plotter application 2122 for control.

The printer application 2112 then instructs the plotter application 2122 to execute a print process (step S2307). At this time, information to be transmitted from the printer application 2112 to the plotter application 2122 is assumed to be “execute (“user name (subject information)”, “plotter”, “full-color”)”.

The plotter application 2122 then requests the authority determining unit 2131 for check (step S2308). At this time, the plotter application 2122 outputs the user name as the subject information, “plotter” as the resource information, and “full-color” as the operation information to the authority determining unit 2131.

When accepting the request, the authority determining unit 2131 obtains an authority setting table corresponding to the input resource information or others from the authority setting management DB 2123 (step S2309).

The authority determining unit 2131 then determines whether the user identified with the input user name has authority to use the “plotter” in “full-color” (step S2310). It is assumed in this execution procedure that the user has authority to use.

Next, the authority determining unit 2131 reports the determination result of the authority to use to the plotter application 2122 (step S2311). With this, the plotter application 2122 determines that the user has authority to use in “full-color”.

The printer application 2112 then performs a print process by using the plotter application 2122.

In the MFP 2100 according to the present embodiment, the authority determining unit 2131 determines whether the user has authority to use. With this, the program size of each application and resource can be reduced. Also, the number of working processes for generating each application and resource can be reduced.

Also, in the MFP 2100 according to the present embodiment, the authority determining unit 2131 is configured to determine whether the user has authority to use a resource or program. With this, by revising the authority determining unit 2131 at the MFP 2100, the logic for checking access control can be collectively changed without awareness on a calling side.

### First Modification Example of the Fifth Embodiment

In the fifth embodiment, the authority determining unit 2131 obtains a corresponding authority setting table every time a request for authority determination is accepted. However, instead of obtaining authority setting tables one by one, all authority setting tables may be obtained in advance. Thus, according to a first modification example of the fifth embodiment, an example of obtaining all authority setting tables in advance is explained. Here, each component of the MFP is similar to that in the fifth embodiment, and therefore is not explained herein.

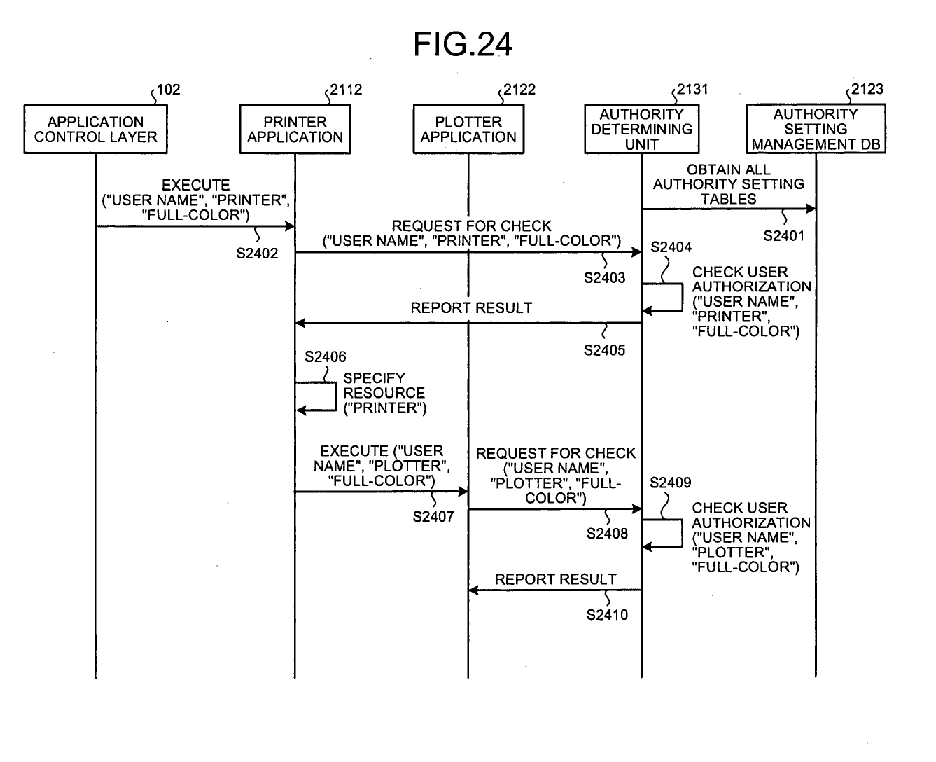

Next, a print process when an input of an instruction for a full-color print process is accepted from the user is explained. FIG. 24 is a sequence diagram of an execution procedure when an instruction for executing a full-color print process is issued from the application control layer 102.

First, the authority determining unit 2131 obtains all authority setting tables from the authority setting management DB 2123 at the time of power-up of the MFP 2100 (step S2401).

Next, the application control layer 102 instructs the printer application 2112 to execute a printer process (step S2402). At this time, information to be transmitted from the application control layer 102 to the printer application 2112 is assumed to be “execute (“user name (subject information)”, “copy”, “full-color”)”. That is, the information includes the user name of the user requesting the process, the requested process (copy), and the operation information for the process (full-color).

Next, the printer application 2112 requests the authority determining unit 2131 for check (step S2403). At this time, the printer application 2112 outputs the user name as the subject information, “printer” as the resource information, and “full-color” as the operation information to the authority determining unit 2131.

The authority determining unit 2131 then determines by using the authority setting tables obtained in advance whether the user identified with the input user name has authority to use the “printer” in “full-color” (step S2404). It is assumed in this execution procedure that the user has authority to use.

Next, the authority determining unit 2131 reports the use authority determination result to the printer application 2112 (step S2405). With this, the printer application 2112 determines that the user has authority to use in “full-color”.

The printer application 2112 then specifies a resource required for control by using the corresponding resource management table 113 (step S2406). It is assumed in this procedure that the plotter unit 108 is specified as a resource required for print. The printer application 2112 then requests the plotter application 2122 for control.

The printer application 2112 then instructs the plotter application 2122 to execute a print process (step S2407). At this time, information to be transmitted from the printer application 2112 to the plotter application 2122 is assumed to be “execute (“user name (subject information)”, “plotter”, “full-color”)”.

The plotter application 2122 then requests the authority determining unit 2131 for check (step S2408). The plotter application 2122 then outputs the user name as the subject information, “plotter” as the resource information, and “full-color” as the operation information to the authority determining unit 2131.

Next, the authority determining unit 2131 determines by using the authority setting tables obtained in advance whether the user identified with the input user name has authority to use the “plotter” in “full-color” (step S2409). It is assumed in this execution procedure that the user has authority to use.

Next, the authority determining unit 2131 reports the use authority determination result to the plotter application 2122 (step S2410). With this, the plotter application 2122 determines that the user has authority to use in “full-color”.

With this, the MFP 2100 according to the present modification example, as with the fifth embodiment, the printer application 2112 can perform a print process by using the plotter application 2122.

In the MFP 2100 according to the present modification example, the authority determining unit 2131 reads the authority setting tables in advance before execution of power-up, for example, thereby increasing the speed of authority determination.

In a sixth embodiment, it is explained that an authority determination is made by authorization server connected to the MFP via a network.

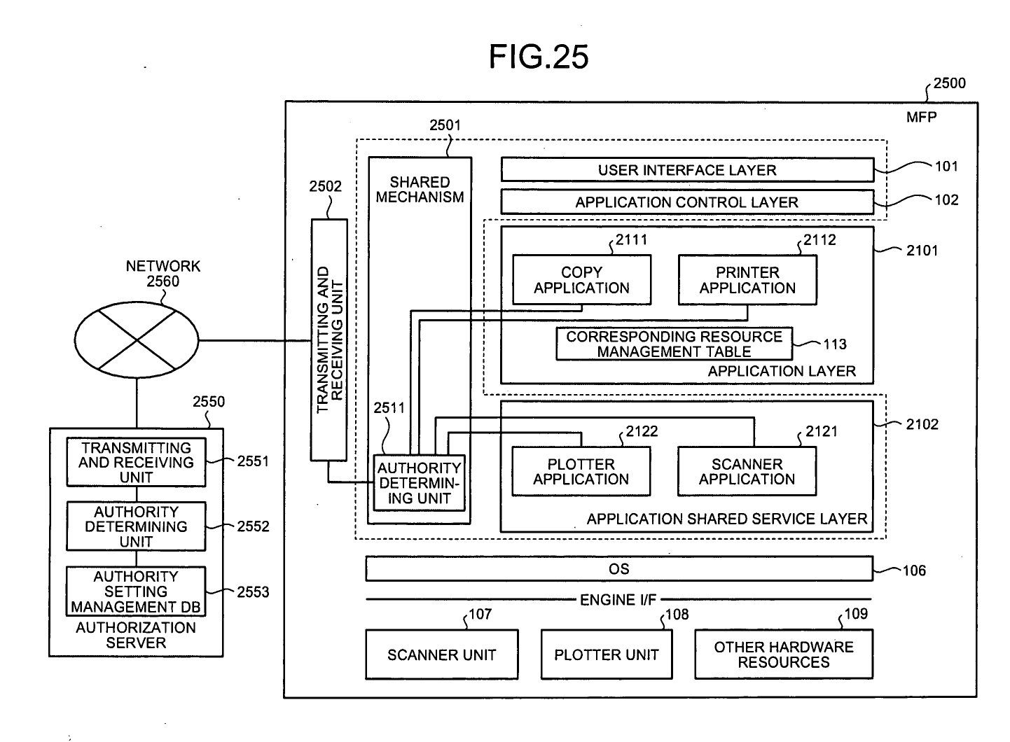

FIG. 25 is a block diagram of the configuration of an MFP 2500 according to the sixth embodiment. As depicted in the drawing, the MFP 2500 is different from the MFP 2100 according to the fifth embodiment in that a transmitting and receiving unit 2502 is added and the shared mechanism 2103 is changed to a shared mechanism 2501 that performs a different process. In the following explanation, components identical to those in the first embodiment are provided with the same reference numerals, and are not explained herein.

As depicted in FIG. 25, an authorization server 2550 is connected to the MFP 2500 via a network 2560.

The authorization server 2550 depicted in FIG. 25 includes a transmitting and receiving unit 2551, an authority determining unit 2552, and an authority setting management DB 2553.

As with the authority setting management DB 2123 according to the fifth embodiment, the authority setting management DB 2553 has held therein, for each piece of operation information in each piece of resource information, information as to whether the user has authority to use in association with each piece of subject information.

The transmitting and receiving unit 2551 transmits and receives information with an apparatus, such as the MFP 2500. For example, the transmitting and receiving unit 2551 receives from the apparatus, such as the MFP 2500, a request for determining whether the user has authority to use, as well as the resource information, the operation information, and the subject information.

Also, the transmitting and receiving unit 2551 transmits the determination result by the authority determining unit 2552 to the apparatus, such as the MFP 2500, which has requested a determination.

The authority determining unit 2552 determines, from the resource information (application or resource name), the operation information, and the subject information (user name) transmitted together with the use authority determination request, whether the user with the user name has authority to use the resource or program indicated by the resource information under the operation information, by using the authority setting management DB 2533.

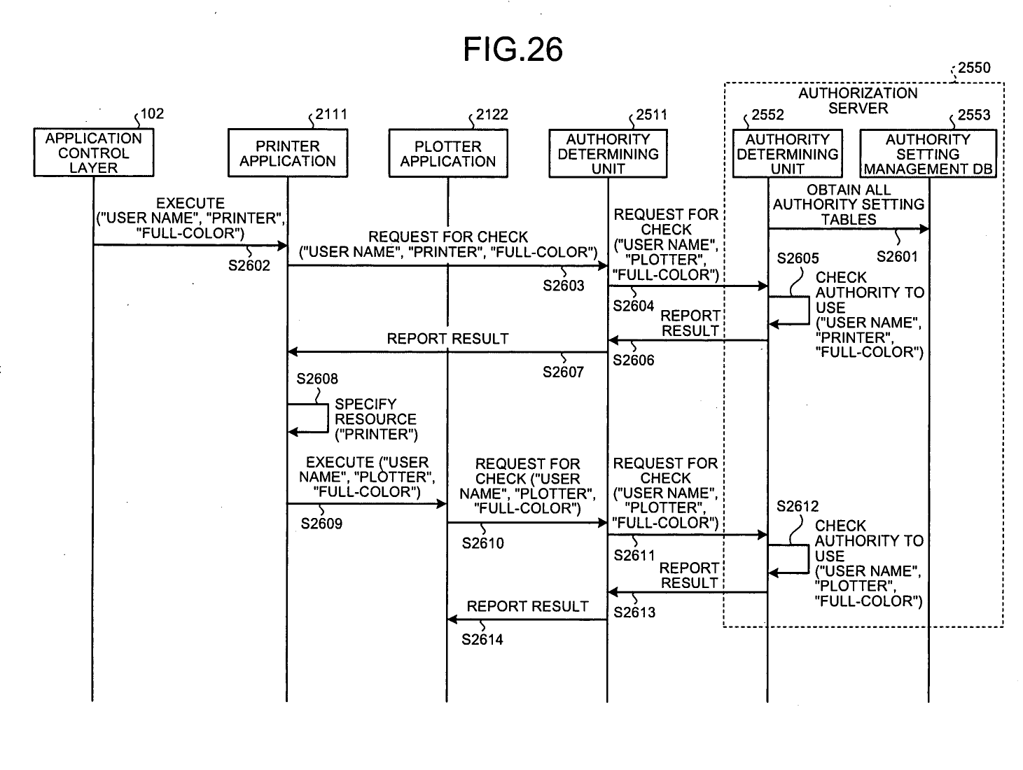

Next, a print process when an input indicative of full-color printing is accepted from the user is explained. FIG. 26 is a sequence diagram of an execution procedure when an instruction for executing a full-color print process is issued from the application control layer 102.

First, at the time of power-up of the authorization server 2550, the authority determining unit 2552 of the authorization server 2550 obtains all authority setting tables from the authority setting management DB 2553 (step S2601).

Next, the application control layer 102 instructs the printer application 2112 to execute a printer process (step S2602). At this time, information to be transmitted from the application control layer 102 to the printer application 2112 is assumed to be “execute (“user name (subject information)”, “printer”, “full-color”)”. That is, the information includes the user name of the user requesting the process, the requested process (print), and the operation information for the process (full-color).

Next, the printer application 2112 requests an authority determining unit 2511 for check (step S2603). At this time, the printer application 2112 outputs the user name as the subject information, the “printer” as the resource information, and “full-color” as the operation information to the authority determining unit 2131.

The authority determining unit 2511 then requests the authorization server 2550 connected via the network for check (step S2604).

Next, the authority determining unit 2552 of the authorization server 2550 uses the authority setting tables obtained in advance to determine whether the user identified with the input user name has authority to use the “printer” in “full-color” (step S2605). It is assumed in this execution procedure that the user has authority to use.

Next, the authority determining unit 2552 reports the use authority determination result to the authority determining unit 2511 (step S2606).

Then, at steps S2607 to S2610, processes similar to those at steps S2405 to S2408 of FIG. 24 are performed.

The authority determining unit 2511 then requests the authorization server 2550 connected via the network for check (step S2611).

Next, the authority determining unit 2552 of the authorization server 2550 uses the authorization setting tables obtained in advance to determine whether the user identified with the input user name has authority to use the “plotter” in “full-color (step S2612). It is assumed in this execution procedure that the user has authority to use.

Next, the authority determining unit 2552 reports the use authority determination result to the authority determining unit 2511 of the MFP 2500 (step S2613). The authority determining unit 2511 then reports the use authority determination result to the plotter application 2122 (step S2614).

With this, the MFP 2500 according to the present embodiment can make access control according to the authority determination result from the authorization server 2550.

Also, in the MFP 2500 according to the present embodiment, an authority determination is devolved to the authorization server 2550. With this, a workload of setting use authority to a plurality of MFPs can be reduced.

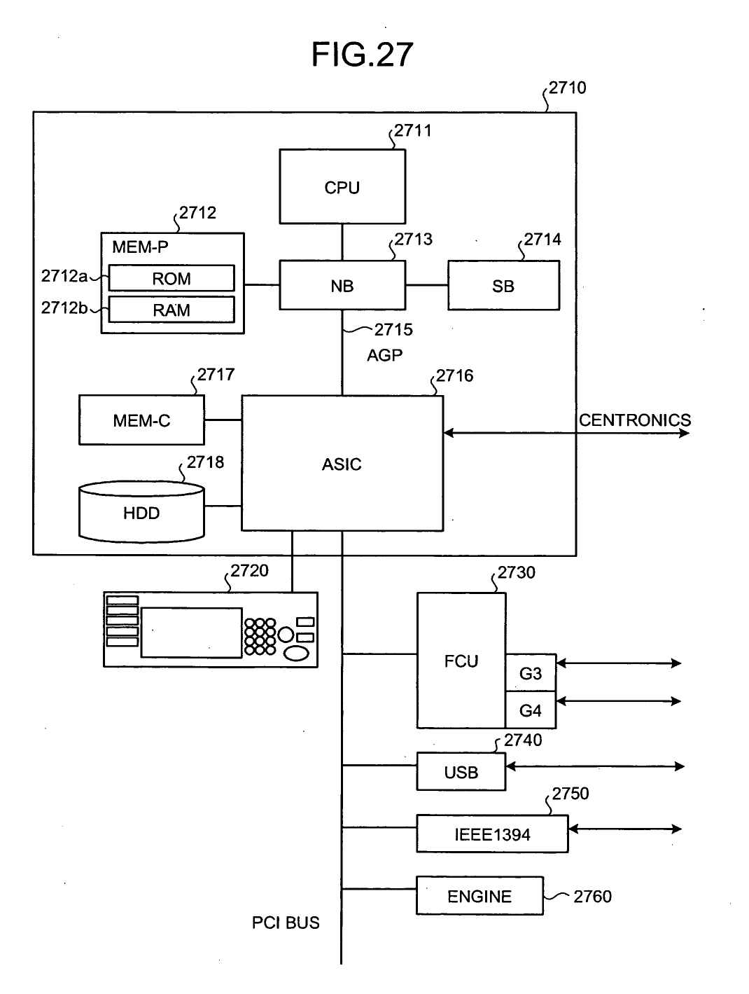

FIG. 27 is a block diagram of a hardware configuration of the MFPs (100, 700, 1200, 1500, 1700, 1800, 2000, 2100, and 2500) according to the embodiments. As depicted in the drawing, these MFPs (100, 700, 1200, 1500, 1700, 1800, 2000, 2100, and 2500) each has a configuration in which a controller 2710 and an engine unit (Engine) 2760 are connected via a Peripheral Component Interconnect (PCI) bus. The controller 2710 is a controller that controls the entire MFP, rendering, communication, and inputs from an operating unit 2720. The engine unit 2760 is, for example, a printer engine connectable to the PCI bus. Examples of the engine unit 2760 are, for example, a monochrome plotter, a one-drum color plotter, a four-drum color plotter, a scanner, or a facsimile unit. Here, this engine unit 2760 includes, in addition to a so-called engine unit, such as a plotter, an image processing unit for error diffusion or gamma transformation.

The controller 2710 includes a CPU 2711, a northbridge (NB) 2713, a system memory (MEM-P) 2712, a southbridge (SB) 2714, a local memory (MEM-C) 2717, an Application Specific Integrated Circuit (ASIC) 2716, and a hard disk drive (HDD) 2718, with the northbridge (NB) 2713 and the ASIC 2716 being connected via an Accelerated Graphics Port (AGP) bus 2715. Also, the MEM-P 2712 further includes a Read Only Memory (ROM) 2712a and a Random Access Memory (RAM) 2712b.

The CPU 2711 performs the overall control over the MFP (100, 700, 1200, 1500, 1700, 1800, 2000, 2100, or 2500), has a chip set formed of the NB 2713, the MEM-P 2712, and the SB 2714. Via this chip set, the CPU 11 is connected to other devices.

The NB 2713 is a bridge for connection of the CPU 2711 with the MEM-P 2712, the SB 2714, and the AGP 2715, and has a memory controller that controls read and write with respect to the MEM-P 2712, a PCI master, and an AGP target.

The MEM-P 2712 is a system memory for use as a memory for storing programs and data, a memory for developing the programs and data, or a rendering memory for printers, and includes the ROM 2712a and the RAM 2712b. The ROM 2712a is a read-only memory for use as a memory for storing programs and data, whilst the RAM 2712b is a writable and readable memory for use as a rendering memory for printers.

The SB 2714 is a bridge for connection between the NB 2713 and PCI devices and peripheral devices. This SB 2714 is connected to the NB 2713 via the PCI bus. To this PCI bus, the network interface (I/F) unit is connected, for example.

The ASIC 2716 is an integrated circuit (IC) dedicated for image processing having hardware components for image processing, serving as a bridge connecting the AGP 2715, the PCI bus, the HDD 2718, and the MEM-C 2717. This ASIC 2716 includes a PCI target and an AGP master, an arbiter (ARB), which is a core of the ASIC 2716, a memory controller that controls the MEM-C 2717, a plurality of Direct Memory Access Controllers (DMACs) for rotating image data with hardware logic, and a PCI unit for data transfer via the PCI bus with the engine unit 2760. To this ASIC 2716, a Fax Control Unit (FCU) 2730, a Universal Serial Bus (USB) 2740, and the Institute of Electrical and Electronic Engineers 1394 (IEEE 1394) interface 2750 are connected.

The MEM-C 2717 is a local memory for use as an image buffer for copy or a code buffer. The Hard Disk Drive (HDD) 2718 is a storage for storing image data, programs, font data, and forms.

The AGP 2715 is a bus interface for a graphics accelerator card suggested for increasing speed of graphic processing and, by directly accessing the MEM-P 2712 with a high throughput, increases the speed of the graphic accelerator card.

Here, an information processing program to be executed on the MFPs (100, 700, 1200, 1500, 1700, 1800, 2000, 2100, and 2500) in the embodiments is provided as being incorporated in advance in a ROM or the like.

Also, the information processing program to be executed on the MFPs (100, 700, 1200, 1500, 1700, 1800, 2000, 2100, and 2500) in the embodiments may be configured to be recorded as a file in an installable or executable format on a computer-readable recording medium for provision, such as a Compact-Disk Read-Only Memory (CD-ROM), a flexible disk (FD), a Compact-Disk Recordable (CD-R), or a Digital Versatile Disk (DVD).

Furthermore, the information processing program to be executed on the MFPs (100, 700, 1200, 1500, 1700, 1800, 2000, 2100, and 2500) in the embodiments may be configured to be stored on a computer connected to a network, such as the Internet, and is downloaded via the network for provision. Also, the information processing program to be executed on the MFPs (100, 700, 1200, 1500, 1700, 1800, 2000, 2100, and 2500) in the embodiments may be configured to be provided or distributed via a network, such as the Internet.

The information processing program to be executed on the MFPs (100, 700, 1200, 1500, 1700, 1800, 2000, 2100, and 2500) in the embodiments has a module configuration including each unit explained above (the shared mechanism, the user interface layer, the application control layer, the application layer, and the application shared service layer). As actual hardware, the CPU (processor) reads the information processing program from the ROM for execution, thereby loading each unit onto a main storage device and generating the shared mechanism, the user interface layer, the application control layer, the application layer, and the application shared service layer on the main storage device.

According to the embodiment of the present invention, an effect can be achieved that accesses to resources can be restricted with easy settings without setting for each application.

According to the embodiment of the present invention, it is determined whether the user has authority to use the resource and application. Therefore, an effect can be achieved that an access control can be made according to granularity of each component included in the information processing apparatus.

According to the embodiment of the present invention, an effect can be achieved that setting items regarding access control to the resources can be easily changed by replacing a resource control application.

According to the embodiment of the present invention, a setting change at the time of adding or deleting a user can be made by adding or deleting one table. Therefore, an effect of workload reduction can be achieved.

According to the embodiment of the present invention, an effect can be achieved that a workload of setting authority to use for each information processing apparatus can be reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an input accepting unit that accepts from a user an input of a request for executing a process and an input of an operation setting at the time of performing the process;
a plurality of applications that each perform the process according to the request for executing the process input from the user;
a plurality of resources commonly used by the applications;
a resource authority determining unit that determines, when a request for the process with the input operation setting is issued from one of the applications to an arbitrary one of the resources, whether the user inputting the operation setting has authority to use the operation setting at the arbitrary resource; and
a resource control application that controls the arbitrary resource with the operation setting when the resource authority determining unit determines that the user has authority to use.

2. The information processing apparatus according to claim 1, further comprising an application authority determining unit that determines, when the application executes the process with the input operation setting, whether the user inputting the operation setting has authority to use the operation setting at the application, wherein
when the application authority determining unit determines that the user has authority to use, the application requests the resource control application for the process with the operation setting.

3. The information processing apparatus according to claim 2, wherein
when the application authority determining unit determines that the user has authority to use, the application further changes the operation setting to an operation setting processable by the resource.

4. The information processing apparatus according to claim 2, wherein
the application authority determining unit is stored for each application requiring a determination as to whether the user has authority to use.

5. The information processing apparatus according to claim 1, wherein
the resource authority determining unit is included in the resource control application that controls the relevant one of the resources.

6. The information processing apparatus according to claim 1, further comprising:
intermediate software having a function of being used by the applications in a shared manner; and
an intermediate-software authority determining unit that determines, when a process with the input operation setting is requested from the application to the intermediate software, whether the user has authority to use the operation setting at the intermediate software, wherein
when the intermediate-software authority determining unit determines that the user has authority to use, the intermediate software requests the resource control application for the process with the operation setting.

7. The information processing apparatus according to claim 1, further comprising a table for each piece of user information for identifying users, the table further including resource authority setting information that holds, for each operation setting executable by the resource, information as to whether the user has authority to use the operation setting, wherein
the resource authority determining unit determines based on the resource authority setting information whether the user has authority to use the operation setting input by the user.

8. The information processing apparatus according to claim 1, further comprising:
a transmitting unit that transmits user information for identifying the user, the operation setting input by the user, and information for identifying the resource to another information processing apparatus connected via a network; and
a receiving unit that receives from the other information processing apparatus authority information indicative of whether the user has authority to use, wherein
the resource authority determining unit determines based on the received authority information whether the user has authority to use.

9. An information processing method comprising:
accepting from a user an input of a request for executing a process of an application and an input of an operation setting at the time of performing the process;
determining, when a request for the process with the input operation setting is issued from the application to an arbitrary one of the resources which are commonly used by a plurality of applications, whether the user inputting the operation setting has authority to use the operation setting at the arbitrary resource; and
controlling the arbitrary resource with the operation setting when it is determined that the user has authority to use.

10. The information processing method according to claim 1, further comprising determining, when the application executes the process with the input operation setting, whether the user inputting the operation setting has authority to use the operation setting at the application.

11. The information processing method according to claim 10, wherein
when it is determined that the user has authority to use, the application further changes the operation setting to an operation setting processable by the resource.

12. The information processing method according to claim 9, further comprising:
determining, when a process with the input operation setting is requested from the application to intermediate software having a function of being used by the plurality of applications in a shared manner, whether the user has authority to use the operation setting at the intermediate software.

13. The information processing method according to claim 9, further comprising
at the determining, whether the user has authority to use the operation setting is determined based on resource authority setting information,
wherein the resource authority setting information holds, for each operation setting executable by the resource and for each piece of user information for identifying users, information as to whether the user has authority to use the operation setting.

14. The information processing method according to claim 9, further comprising
transmitting user information for identifying the user, the operation setting input by the user, and information for identifying the resource to an information processing apparatus via a network; and
receiving from the information processing apparatus authority information indicative of whether the user has authority to use, wherein
at the determining, whether the user has authority to use the operation setting is determined based on the received authority information.

15. A computer program product that includes a computer-readable recording medium that stores therein a computer program that causes a computer to implement an information processing, the computer program causing the computer to execute:
accepting from a user an input of a request for executing a process of an application and an input of an operation setting at the time of performing the process;
determining, when a request for the process with the input operation setting is issued from the application to an arbitrary one of the resources which are commonly used by a plurality of applications, whether the user inputting the operation setting has authority to use the operation setting at the arbitrary resource; and
controlling the arbitrary resource with the operation setting when it is determined that the user has authority to use.

16. The computer program product according to claim 15, wherein the computer program further causing the computer to execute determining, when the application executes the process with the input operation setting, whether the user inputting the operation setting has authority to use the operation setting at the application.

17. The computer program product according to claim 16, wherein
when it is determined that the user has authority to use, the application further changes the operation setting to an operation setting processable by the resource.

18. The computer program product according to claim 15, wherein the computer program further causing the computer to execute determining, when a process with the input operation setting is requested from the application to intermediate software having a function of being used by the plurality of applications in a shared manner, whether the user has authority to use the operation setting at the intermediate software.

19. The computer program product according to claim 15, wherein
at the determining, whether the user has authority to use the operation setting is determined based on resource authority setting information,
wherein the resource authority setting information holds, for each operation setting executable by the resource and for each piece of user information for identifying users, information as to whether the user has authority to use the operation setting.

20. The computer program product according to claim 15, wherein the computer program further causing the computer to execute
transmitting user information for identifying the user, the operation setting input by the user, and information for identifying the resource to an information processing apparatus via a network; and
receiving from the information processing apparatus authority information indicative of whether the user has authority to use, wherein
at the determining, whether the user has authority to use the operation setting is determined based on the received authority information.
